(19) United States
(12) Patent Application Publication
(10) Pub. No.: US 2026/0277145 A1
(43) Pub. Date: Sep. 17, 2026

(54) INFORMATION PROCESSING SYSTEM, RECORDING MEDIUM ACCOMMODATING DEVICE, IMAGE FORMING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Ryosuke YONESAKA, Kanagawa (JP); Kazuhiko HORIKAWA, Kanagawa (JP); Yuichi ARAKI, Kanagawa (JP)

(73) Assignee: FUJIFILM Business Innovation Corp., Tokyo (JP)

(21) Appl. No.: 19/277,402

(22) Filed: Jul. 23, 2025

(30) Foreign Application Priority Data
Mar. 17, 2025 (JP) 2025-042682

(51) Int. Cl. G03G 15/00

(52) U.S. Cl. CPC G03G 15/6511; G03G 15/5029; G03G 15/6558; G03G 15/657; G03G 2215/004; G03G 2215/00616

(57) ABSTRACT

An information processing system includes a processor configured to: acquire a medium image that is an image of a bundle of recording media including plural recording media, the bundle of recording media being in a state in which gas is being blown from a lateral side of the recording media; and generate information regarding a floating state of the bundle of recording media shown in the acquired medium image by using a trained model generated through machine learning using training data including an image of a bundle of recording media that is in a state in which gas is being blown from a lateral side and information regarding a floating state of the bundle of recording media shown in the image.

### CROSS-REFERENCE TO RELATED APPLICATIONS

This application is based on and claims priority under 35 USC 119 from Japanese Patent Application No. 2025-042682 filed Mar. 17, 2025.

### BACKGROUND

### (i) Technical Field

The present disclosure relates to an information processing system, a recording medium accommodating device, an image forming apparatus, a non-transitory computer readable medium storing a program, and an information processing method.

### (ii) Related Art

JP6347066B discloses an image forming apparatus including a blowing unit that blows air onto a sheet bundle to float an uppermost sheet, and a conveying unit that adsorbs the uppermost sheet floated by the blowing unit and that conveys the uppermost sheet in a conveyance direction.

### SUMMARY

In a case where information regarding a floating state of a bundle of recording media onto which gas is being blown is generated, for example, a determination can be made, based on this information, as to whether an airflow rate of the gas is favorable or not.

Here, in a state in which the recording media are being floated, a position of each of the recording media tends to fluctuate, making it difficult to specify the position of each of the recording media. In this case, in a case where the information regarding the floating state of the bundle of recording media is generated based on the position of the recording medium, the accuracy of the generated information decreases.

Aspects of non-limiting embodiments of the present disclosure relate to an information processing system, a recording medium accommodating device, an image forming apparatus, a non-transitory computer readable medium storing a program that enhance accuracy of generating information regarding a floating state of a bundle of recording media, as compared with a case where the information regarding the floating state of the bundle of recording media is generated based only on a detection result of a position of the recording medium constituting the bundle of recording media.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: a processor configured to: acquire a medium image that is an image of a bundle of recording media consisting of a plurality of recording media, the bundle of recording media being in a state in which gas is being blown from a lateral side of the recording media; and generate information regarding a floating state of the bundle of recording media shown in the acquired medium image by using a trained model generated through machine learning using training data including an image of a bundle of recording media that is in a state in which gas is being blown from a lateral side and information regarding a floating state of the bundle of recording media shown in the image.

### BRIEF DESCRIPTION OF THE DRAWINGS

Exemplary embodiment(s) of the present invention will be described in detail based on the following figures, wherein:

FIG. 1 is a diagram showing an image forming apparatus;

FIG. 2 is a diagram showing an example of a hardware configuration of a control unit;

Parts (A) to (C) in FIG. 3 are diagrams showing a state of a paper bundle onto which gas is being blown;

FIG. 4 is a perspective view of a paper accommodating device as viewed from a front side of the image forming apparatus;

FIG. 5 is a view of the paper accommodating device as viewed in a direction indicated by an arrow V in FIG. 4;

FIG. 6 is a flowchart showing an example of a flow of a decision process for deciding on a content of a blowing setting;

FIG. 7 is a diagram illustrating processing of step S105;

FIG. 8 is a diagram showing processing in a case of generating a trained model;

FIGS. 9A to 9C are diagrams showing paper images obtained by an imaging unit;

Parts (A) to (E) in FIG. 10 are diagrams showing a state of a floating paper bundle;

FIG. 11 is a flowchart showing a flow of processing of reading and acquiring the blowing setting;

FIG. 12 is a flowchart showing a flow of processing in consideration of folding of paper; and

FIG. 13 is a flowchart showing a flow of processing of switching trained models in accordance with the number of sheets of paper.

### DETAILED DESCRIPTION

Hereinafter, exemplary embodiments of the present disclosure will be described with reference to the accompanying drawings.

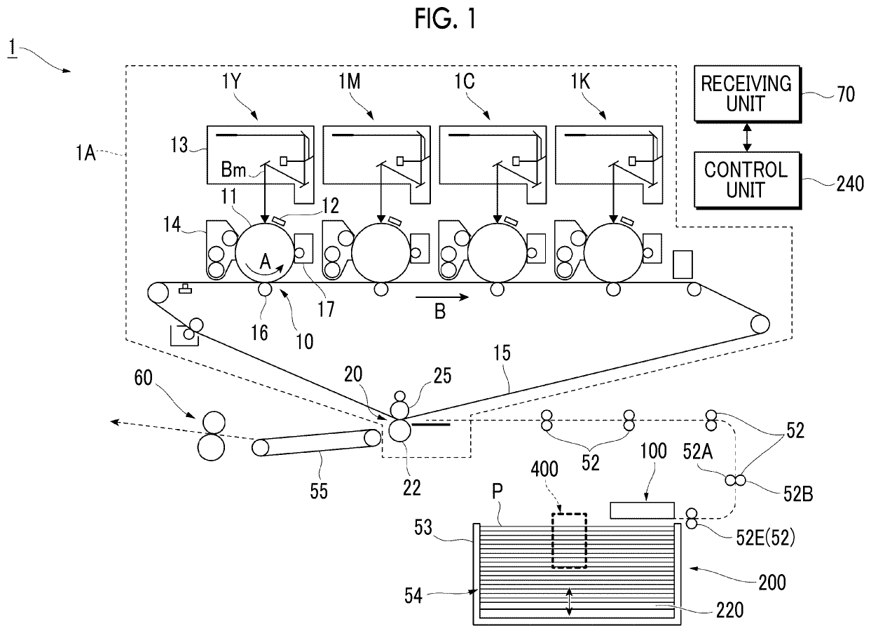

FIG. 1 is a diagram showing an image forming apparatus 1 according to the present exemplary embodiment.

The image forming apparatus 1 shown in FIG. 1 is the image forming apparatus 1 of an intermediate transfer type called a tandem type. The image forming apparatus 1 is provided with a paper accommodating device 200 that accommodates paper P, which is an example of a recording medium.

Additionally, the image forming apparatus 1 is provided with an image forming section 1A. The image forming section 1A forms an image on the paper P fed out from the paper accommodating device 200.

The image forming section 1A is provided with a plurality of image forming units 1Y, 1M, 1C, and 1K. Each of the plurality of image forming units 1Y, 1M, 1C, and 1K forms a toner image of a corresponding color component by using an electrophotographic method.

Additionally, the image forming section 1A is provided with a primary transfer unit 10. The toner images of respective colors formed by the image forming units 1Y, 1M, 1C, and 1K are transferred onto an intermediate transfer belt 15 by the primary transfer unit 10.

Further, the image forming section 1A is provided with a secondary transfer unit 20. The toner images transferred onto the intermediate transfer belt 15 are transferred onto the paper P by the secondary transfer unit 20.

In addition, the image forming apparatus 1 is provided with a fixing device 60 that fixes the toner image secondarily transferred onto the paper P to the paper P.

The image forming apparatus 1 is further provided with a control unit 240. In the present exemplary embodiment, a CPU provided in the control unit 240 executes processing of information regarding the paper P as will be described below. The control unit 240 can be regarded as an information processing system that processes information regarding the paper P.

The image forming apparatus 1 is further provided with a receiving unit 70 that receives information input by a user.

The receiving unit 70 is configured, for example, by a touch panel. The receiving unit 70 has, in addition to a reception function of receiving information from the user, a display function of displaying the information.

A device for implementing the reception function and a device for implementing the display function may be individually provided.

### Configuration of Control Unit 240

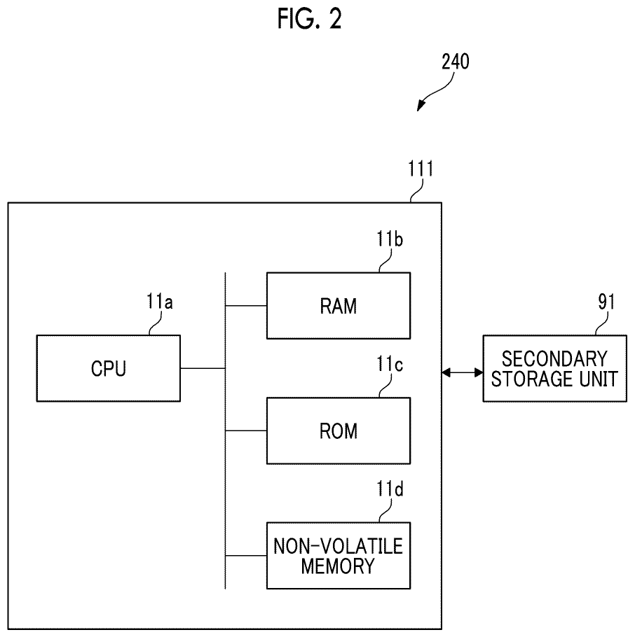

FIG. 2 is a diagram showing an example of a hardware configuration of the control unit 240. The control unit 240 is implemented by a computer.

The control unit 240 includes a computation processing unit 111 that executes digital computation processing in accordance with a program, and a secondary storage unit 91 that stores information.

The secondary storage unit 91 is implemented, for example, by an existing information storage device, such as a hard disk drive (HDD), a semiconductor memory, or a magnetic tape.

The computation processing unit 111 is provided with a CPU 11a as an example of a processor.

In addition, the computation processing unit 111 is provided with a RAM 11b that is used as a work memory or the like of the CPU 11a. The computation processing unit 111 is further provided with a ROM 11c that stores a program and the like executed by the CPU 11a.

Furthermore, the computation processing unit 111 is provided with a non-volatile memory 11d that can retain data even in a case where power supply is interrupted.

The non-volatile memory 11d is configured, for example, as a battery-backed SRAM, a flash memory, or the like. The secondary storage unit 91 stores various kinds of information, such as a program executed by the computation processing unit 111.

In the present exemplary embodiment, the CPU 11a of the computation processing unit 111 reads the program stored in the ROM 11c or the secondary storage unit 91. The CPU 11a executes the program stored in the ROM 11c or the secondary storage unit 91. Consequently, various kinds of processing performed by the image forming apparatus 1 are executed. Various kinds of processing performed by the image forming apparatus 1 are executed by the CPU 11a.

The program executed by the CPU 11a may be provided to the image forming apparatus 1 via a recording medium.

An example of the recording medium includes a magnetic recording medium, such as a magnetic tape or a magnetic disk. In addition, another example of the recording medium includes an optical recording medium, such as an optical disc.

Further, still another example of the recording medium includes a magneto-optical recording medium. Furthermore, still another example of the recording medium includes a semiconductor memory or the like.

Additionally, the program executed by the CPU 11a may be provided to the image forming apparatus 1 by using communication means such as the Internet.

With reference to FIG. 1, the image forming apparatus 1 will be further described.

The following devices are installed in each of the image forming units 1Y, 1M, 1C, and 1K.

First, a photosensitive drum 11 that rotates in a direction of an arrow A is provided. A charger 12 that charges the photosensitive drum 11 is provided around the photosensitive drum 11. An exposure device 13 that forms an electrostatic latent image on the photosensitive drum 11 is further provided. Furthermore, a developing unit 14 that develops the electrostatic latent image on the photosensitive drum 11 with a toner is provided.

Additionally, each of the image forming units 1Y, 1M, 1C, and 1K is provided with a primary transfer roller 16. The primary transfer roller 16 is provided in the primary transfer unit 10. The toner image formed on the photosensitive drum 11 is transferred onto the intermediate transfer belt 15 by the primary transfer roller 16.

Further, each of the image forming units 1Y, 1M, 1C, and 1K is provided with a drum cleaner 17. The drum cleaner 17 removes residual toner and the like remaining on the photosensitive drum 11.

The intermediate transfer belt 15 circulates in a direction of an arrow B shown in FIG. 1 at a predetermined speed.

The primary transfer unit 10 includes the primary transfer roller 16 that is disposed to face the photosensitive drum 11 with the intermediate transfer belt 15 sandwiched therebetween.

In the present exemplary embodiment, the toner images on the respective photosensitive drums 11 are sequentially electrostatically attracted onto the intermediate transfer belt 15. Consequently, a superimposed toner image is formed on the intermediate transfer belt 15.

The secondary transfer unit 20 includes a secondary transfer roller 22 that is disposed to face an outer peripheral surface of the intermediate transfer belt 15, and a backup roller 25.

The secondary transfer roller 22 is pressed against the backup roller 25 with the intermediate transfer belt 15 sandwiched therebetween. A voltage is applied between the secondary transfer roller 22 and the backup roller 25. In the present exemplary embodiment, the toner image on the intermediate transfer belt 15 is transferred onto the paper P conveyed to the secondary transfer unit 20.

In the present exemplary embodiment, the paper P fed out from the paper accommodating device 200 is conveyed to the secondary transfer unit 20. The toner image on the intermediate transfer belt 15 is transferred onto the paper P fed out from the paper accommodating device 200.

In the present exemplary embodiment, image data is output to the image forming apparatus 1 from an image scan device (not shown), a personal computer (PC), or the like.

Then, image processing is performed on the image data by an image processing device (not shown). Consequently, image data of four colors Y, M, C, and K is generated. The generated image data is output to the exposure device 13 provided for each of the colors Y, M, C, and K.

The exposure device 13 irradiates the photosensitive drum 11 with light in response to the input image data.

For exposure of the photosensitive drum 11 by the exposure device 13, for example, a semiconductor laser is used. In addition, for exposure of the photosensitive drum 11 by the exposure device 13, for example, a light emitting diode (LED) is used.

In each of the photosensitive drums 11, a surface is charged by the charger 12. Thereafter, the surface is subjected to scanning exposure by the exposure device 13, and an electrostatic latent image is formed on the surface.

Next, toner is attached to the photosensitive drum 11 by the developing unit 14. Consequently, a toner image is formed on the photosensitive drum 11.

The toner image formed on the photosensitive drum 11 is transferred onto the intermediate transfer belt 15 by the primary transfer unit 10.

After this toner image is transferred onto a surface of the intermediate transfer belt 15, the toner image is moved to the secondary transfer unit 20 by the moving intermediate transfer belt 15.

In the secondary transfer unit 20, the secondary transfer roller 22 is pressed against the backup roller 25 via the intermediate transfer belt 15.

In the present exemplary embodiment, the paper P fed out from the paper accommodating device 200 is sandwiched between the intermediate transfer belt 15 and the secondary transfer roller 22.

Consequently, an unfixed toner image held on the intermediate transfer belt 15 is transferred onto the paper P by the secondary transfer unit 20. Thereafter, the paper P onto which the toner image has been transferred is discharged to a paper discharge section (not shown) after passing through the fixing device 60.

### Description of Paper Accommodating Device

The paper accommodating device 200 as an example of a recording medium accommodating device is provided with an accommodating section 53 that accommodates the paper P to be loaded. A plurality of sheets of paper P are accommodated in the accommodating section 53.

The accommodating section 53 is provided with a support base 220 that supports the paper P to be loaded from below.

In a case where the paper P is set in the paper accommodating device 200, the paper P is placed on the support base 220 by the user. Thereafter, the support base 220 rises.

In a case where the support base 220 rises, the paper P on the support base 220 approaches a suction unit 100. In the present exemplary embodiment, the uppermost paper P among sheets of paper P accommodated in the paper accommodating device 200 is fed out by the suction unit 100.

The accommodating section 53 is further provided with a side guide against which a side edge of the paper P is abutted and which is used to position the paper P, or the like.

In the present exemplary embodiment, a paper bundle 54 is composed of a plurality of sheets of paper P loaded in the paper accommodating device 200. The paper bundle 54 as an example of a bundle of recording media is composed of the plurality of sheets of paper P.

In the present exemplary embodiment, the uppermost paper P among the sheets of paper P included in the paper bundle 54 is fed out.

Then, the toner image formed by the image forming section 1A is transferred onto the paper P that has been fed out, by the secondary transfer unit 20. The image forming section 1A forms an image composed of toner images on the paper P fed out from the accommodating section 53.

The paper accommodating device 200 is further provided with a blowing device 400 that blows gas onto the paper P loaded in the paper accommodating device 200.

Additionally, although not shown in FIG. 1, the paper accommodating device 200 is provided with a light source 600 that irradiates the paper P with light. Further, the paper accommodating device 200 is provided with an imaging unit 500 that images the paper P.

The light source 600 and the imaging unit 500 will be described below.

In the present exemplary embodiment, in a case where the feeding out of the paper P is performed, gas is blown onto the loaded paper P by the blowing device 400. In the present exemplary embodiment, gas is blown onto the paper P from a lateral side of the loaded paper P.

Consequently, the paper P is floated. In addition, gas enters between the sheets of paper P.

In a case where gas enters between the sheets of paper P, adhesion between the sheets of paper P is released. In this case, so-called double feeding, in which sheets of paper P are fed out in a state in which a plurality of sheets of paper P overlap each other, is less likely to occur.

In the present exemplary embodiment, the blowing device 400 is provided on both a front side and a back side of the paper bundle 54 shown in FIG. 1. In the present exemplary embodiment, gas is blown onto the paper P from both the front side and the back side. The blowing device 400 may be provided only on one side of the front side or the back side.

In the present exemplary embodiment, as the gas, air is blown. Note that the type of gas is not particularly limited. Gas other than air may be blown onto the paper P.

Additionally, the paper accommodating device 200 may be provided with a heater serving as a heat source. In this case, heated gas is blown onto the loaded paper P.

In addition, in the present exemplary embodiment, the suction unit 100 that sucks the sheets of paper P constituting the paper bundle 54 is provided above the paper bundle 54.

Further, a plurality of conveyance rollers 52 that convey the paper P fed out from the paper accommodating device 200 are provided. The conveyance rollers 52 are provided downstream of the paper accommodating device 200 in a conveyance direction of the paper P.

In the present exemplary embodiment, the feeding out of the paper P is performed from the paper accommodating device 200 by the suction unit 100. The paper P fed out from the paper accommodating device 200 is first conveyed by a most upstream conveyance roller 52E.

The term “most upstream conveyance roller 52E” refers to a conveyance roller 52 that is located most upstream in the conveyance direction of the paper P among the plurality of conveyance rollers 52.

Then, the paper P is further conveyed by another conveyance roller 52 located downstream of the most upstream conveyance roller 52E. Consequently, the paper P is directed to the secondary transfer unit 20 and the fixing device 60.

A conveyance belt 55 is further provided downstream of the secondary transfer unit 20 in the conveyance direction of the paper P. The conveyance belt 55 conveys the paper P on which the secondary transfer has been performed to the fixing device 60.

The suction unit 100 as an example of a feeder feeds out the paper P loaded in the paper accommodating device 200 toward the most upstream conveyance roller 52E.

The suction unit 100 sucks and holds the uppermost paper P among the sheets of paper P loaded in the paper accommodating device 200.

Then, the suction unit 100 moves toward the most upstream conveyance roller 52E in a state of holding the paper P. Consequently, the feeding out of the paper P included in the loaded sheets of paper P is performed. Specifically, the feeding out of the uppermost paper P among the loaded sheets of paper P is performed.

The paper P fed out by the suction unit 100 is delivered to the most upstream conveyance roller 52E. In the present exemplary embodiment, the paper P is delivered from the suction unit 100 to the most upstream conveyance roller 52E.

Consequently, the conveyance of the paper P is started by the most upstream conveyance roller 52E.

The suction unit 100 moves in a direction away from the most upstream conveyance roller 52E after delivering the paper P to the most upstream conveyance roller 52E. As a result, the suction unit 100 returns to an initial position.

In the present exemplary embodiment, in a case where the feeding out of the paper P is performed, a gas blowing function unit blows gas onto the paper P in accordance with a predetermined setting. The gas blowing function unit is configured by the blowing device 400 and the CPU 11a shown in FIG. 2.

In a case where gas is blown onto the paper P, the paper P is floated. The suction unit 100 feeds out the uppermost paper P among the floating sheets of paper P.

In the present specification, hereinafter, the above-described predetermined setting followed by the gas blowing function unit will be referred to as a “blowing setting”.

Parts (A) to (C) in FIG. 3 are diagrams showing a state of the paper bundle 54 onto which gas is being blown.

For example, a preferable airflow rate exists for an airflow rate of the gas to be blown onto the paper bundle 54.

At this airflow rate, as shown in the part (B) in FIG. 3, the paper P constituting the paper bundle 54 floats, and gaps are generated between the individual sheets of paper P.

On the other hand, in a case where the airflow rate is high, as indicated by reference numeral 3D in the part (C) in FIG. 3, overlapping between the sheets of paper P occurs at the upper part of the paper bundle 54. In this case, so-called double feeding, in which a plurality of sheets of paper P are fed out in a bundled state, is likely to occur.

Additionally, in a case where the airflow rate is low, an amount of floating of the paper P decreases, as shown in the part (A) in FIG. 3. In this case, it is difficult for the paper P to reach the suction unit 100 shown in FIG. 1.

In the present exemplary embodiment, as will be described below, the paper bundle 54, in which the paper P is in a floating state, is imaged from the lateral side of the paper bundle 54.

Then, based on a result of the imaging, the airflow rate of the gas to be blown by the blowing device 400 shown in FIG. 1 onto the paper bundle 54 is set. In other words, a content of the above-described blowing setting is decided on.

In a case where the image is formed on the paper P, gas is blown onto the paper bundle 54 under the blowing setting whose content has been decided on.

In this case, the state of the paper bundle 54 is a state shown in the part (B) in FIG. 3.

In the present exemplary embodiment, the CPU 11a as an example of a processor causes the decision process to be performed before the feeding out of the paper P is started.

The “decision process” refers to a process for deciding on the content of the above-described blowing setting.

The CPU 11a outputs a signal for causing the decision process to be performed, thereby causing the decision process to be performed.

The CPU 11a causes the decision process to be performed before the image formation on the paper P, which is initiated by input of a print job to the image forming apparatus 1, is started. Consequently, the decision process is performed before the feeding out of the paper P is started.

More specifically, in the present exemplary embodiment, the CPU 11a causes the decision process to be performed in response to, for example, accommodation of the new paper P in the accommodating section 53.

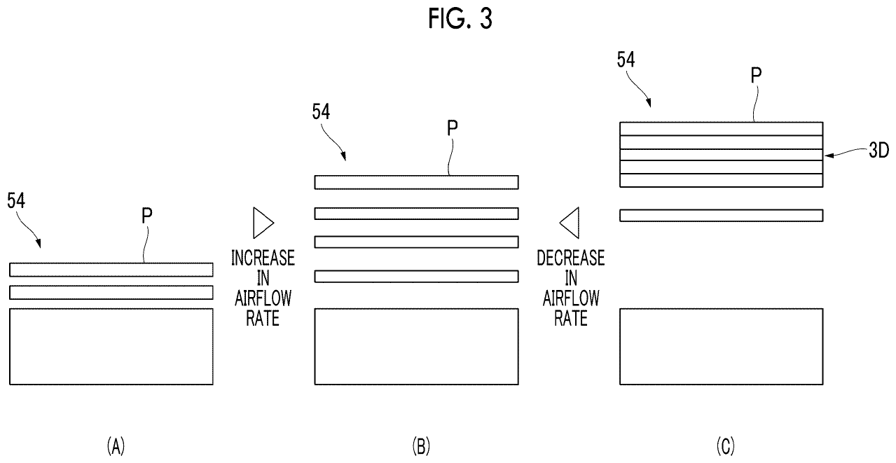

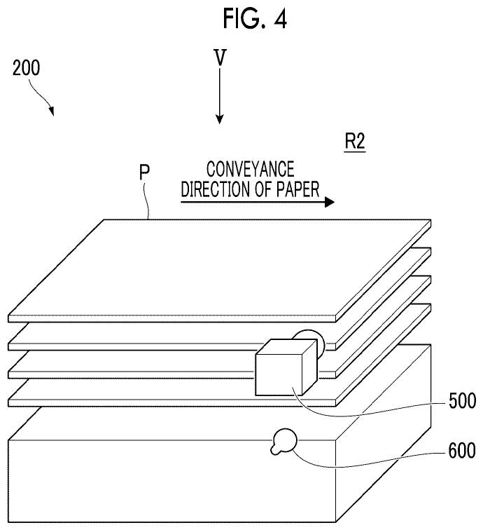

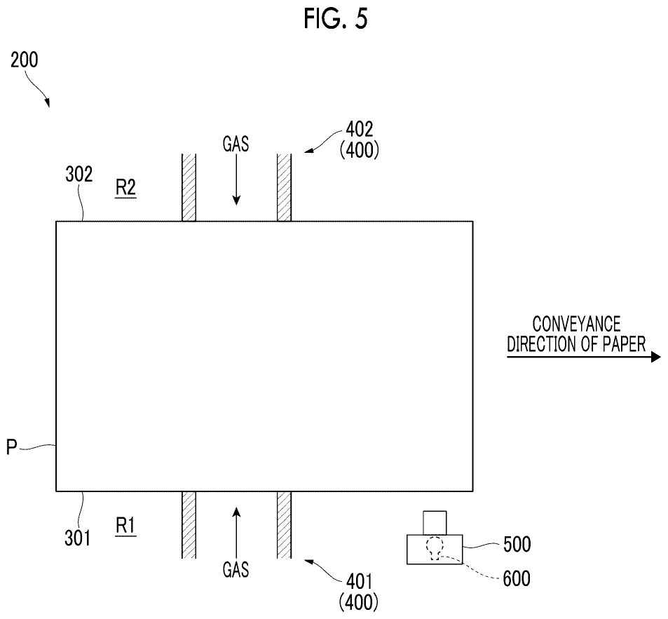

FIG. 4 is a perspective view of the paper accommodating device 200 as viewed from a front side of the image forming apparatus 1. FIG. 5 is a view of the paper accommodating device 200 as viewed in a direction indicated by an arrow V in FIG. 4. In other words, FIG. 5 is a top view of the paper accommodating device 200.

FIG. 4 shows a state in which gas is being blown by the blowing device 400. The blowing device 400 is not shown in FIG. 4.

Meanwhile, in FIG. 5, the blowing device 400 is displayed.

As shown in FIG. 5, in the present exemplary embodiment, a one-side blowing device 401 and the other-side blowing device 402 are provided as the blowing devices 400.

The one-side blowing device 401 is provided on one lateral side R1 of the paper P. In addition, the other-side blowing device 402 is provided on the other lateral side R2 of the paper P.

In the present exemplary embodiment, as shown in FIG. 4, the imaging unit 500 that images the paper P is further provided.

The imaging unit 500 as an example of an imaging unit is provided on the one lateral side R1.

The imaging unit 500 is a so-called camera. The imaging unit 500 is configured, for example, by a CCD or a CMOS.

As the imaging unit 500, a monochrome camera may be used, or a color camera may be used. In addition, a contact image sensor may also be used as the imaging unit 500.

As shown in FIG. 4, the light source 600 is provided on the one lateral side R1. The light source 600 irradiates the paper P, which is to be imaged by the imaging unit 500, with light.

In the present exemplary embodiment, in a case where the paper P is imaged by the imaging unit 500, the light source 600 is turned on.

The installation location of each of the imaging unit 500 and the light source 600 is not particularly limited, and the imaging unit 500 and the light source 600 may be provided on the other lateral side R2 of the paper P. Additionally, a plurality of imaging units 500 and a plurality of light sources 600 may be provided.

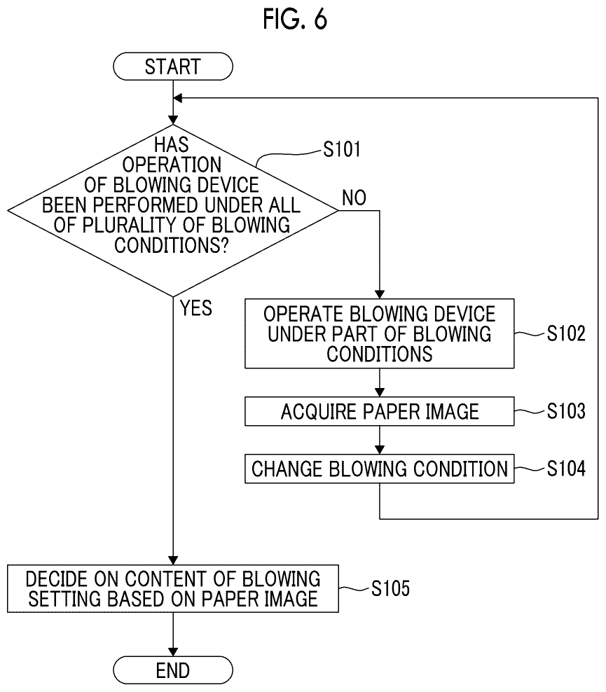

FIG. 6 is a flowchart showing an example of a flow of the above-described decision process for deciding on the content of the above-described blowing setting.

In the present exemplary embodiment, for example, in a case where the accommodation of the paper P in the accommodating section 53 is detected, the decision process is started.

In addition, the decision process may be started after the accommodation of the paper P in the accommodating section 53 has been detected and input of paper information which is information regarding the paper P has been performed by the user.

Examples of the paper information include information regarding the type of paper and information regarding the size of the paper P.

In a case where the decision process is started, first, the CPU 11a determines whether the operation of the blowing device 400 has been performed under all of a plurality of predetermined blowing conditions (step S101).

In the present exemplary embodiment, a plurality of blowing conditions having airflow rates different from each other are set in advance. In step S101, the CPU 11a determines whether gas has been blown onto the paper bundle 54 under all of the plurality of blowing conditions.

In step S101, in a case where the CPU 11a determines that gas has been blown onto the paper bundle 54 under all of the plurality of blowing conditions, the process proceeds to step S105.

In a case where the CPU 11a determines that the operation of the blowing device 400 has been performed under each of all the blowing conditions, the process proceeds to step S105.

On the other hand, in a case where the CPU 11a does not determine in step S101 that gas has been blown onto the paper bundle 54 under all of the plurality of blowing conditions, the process proceeds to step S102.

In step S102, the CPU 11a operates the blowing device 400 under a part of the blowing conditions included in the plurality of blowing conditions.

As a result, the paper P constituting the paper bundle 54 is floated.

Next, the CPU 11a acquires a paper image (step S103).

In the processing of step S103, the CPU 11a operates the imaging unit 500 to image the paper bundle 54. In this case, the CPU 11a turns on the light source 600.

In step S103, the paper bundle 54 that is in a state in which the paper P is being floated is imaged by the imaging unit 500. Consequently, the paper image, which is an image obtained by imaging the paper bundle 54, is acquired. The paper image as an example of a medium image shows the paper bundle 54 that is in a state in which the paper P is being floated.

The “paper image” refers to an image obtained by imaging the paper bundle 54 accommodated in the accommodating section 53 from the lateral side and to an image of the paper bundle 54 that is in a state in which gas is being blown onto the paper bundle 54 from the lateral side of the paper bundle 54.

In the present exemplary embodiment, in a case where the paper image is acquired, the paper image is stored in the secondary storage unit 91 shown in FIG. 2 as an example of an information storage unit.

In storing the paper image, the paper image is stored in the secondary storage unit 91 in a form in which the blowing condition in a case where the paper image is obtained is associated with the paper image.

In the present exemplary embodiment, the paper image and the blowing condition in a case where the paper image is obtained are stored in the secondary storage unit 91 in a state of being associated with each other.

Next, the CPU 11a changes the blowing condition (step S104). In other words, the CPU 11a changes the airflow rate of the gas to be blown onto the paper bundle 54. In other words, the CPU 11a changes a condition for operating the blowing device 400.

Here, the blowing condition can also be referred to as a condition for operating the blowing device 400. In the present exemplary embodiment, the blowing device 400 is operated under each of a plurality of operation conditions set in advance.

After the processing of step S104, the processing of step S101 is performed again.

In step S101, the CPU 11a determines whether gas has been blown onto the paper bundle 54 under all of the plurality of blowing conditions.

In a case where the CPU 11a does not determine in step S101 that gas has been blown onto the paper bundle 54 under all of the plurality of blowing conditions, the processing of steps S102 to S104 is performed again.

In step S101, the processing of steps S102 to S104 is repeatedly performed until determination is made that gas has been blown onto the paper bundle 54 under all of the plurality of blowing conditions.

As a result, in the present exemplary embodiment, the processing of step S104 is performed a plurality of times, and the airflow rate of the gas to be blown onto the paper bundle 54 is changed.

In changing the airflow rate, for example, the airflow rate is changed such that the airflow rate is changed in a stepwise manner from a low airflow rate to a high airflow rate. Alternatively, the airflow rate is changed such that the airflow rate is changed in a stepwise manner from a high airflow rate to a low airflow rate.

However, the present disclosure is not limited thereto, and the airflow rate may be randomly changed.

In a case where determination is made in step S101 that gas has been blown onto the paper bundle 54 under all of the plurality of blowing conditions, the process proceeds to step S105.

In other words, in a case where determination is made in step S101 that the operation of the blowing device 400 has been performed under all of the plurality of blowing conditions, the process proceeds to step S105.

A situation is assumed in which determination is made that gas has been blown onto the paper bundle 54 under all of the plurality of blowing conditions. In this situation, a plurality of data pairs, each including the paper image and the blowing condition, are stored in the secondary storage unit 91.

In step S105, the CPU 11a decides on the content of the above-described blowing setting based on the paper image obtained under each of the blowing conditions. In step S105, the CPU 11a decides on the content of the blowing setting based on the plurality of paper images stored in the secondary storage unit 91.

Specifically, the CPU 11a specifies, from among the plurality of paper images stored in the secondary storage unit 91, a paper image in which, for example, the floating state of the paper P is in a most preferable state.

Then, the CPU 11a decides on the content of the blowing setting based on the paper image in which, for example, the floating state of the paper P is in the most preferable state.

Specifically, the CPU 11a sets, as the blowing setting, the blowing condition exactly as associated with the paper image in which, for example, the floating state of the paper P is in the most preferable state.

Additionally, the CPU 11a may correct the blowing condition associated with the paper image in which, for example, the floating state of the paper P is in the most preferable state, and may set the corrected blowing condition as the blowing setting.

In any case, the CPU 11a decides on the content of the blowing setting based on the blowing condition associated with the paper image in which, for example, the floating state of the paper P is in the most preferable state.

Thereafter, the CPU 11a stores the decided-on content of the blowing setting in the secondary storage unit 91. As a result, the decision process ends.

In the present specification, hereinafter, the paper image in which, for example, the floating state of the paper P is in the most preferable state described above may be referred to as a “best paper image”.

In the present exemplary embodiment, after the decision process shown in FIG. 6 has ended, gas blowing by the blowing device 400 temporarily ends.

The decision process shown in steps S101 to S105 is performed in a preparation stage before the image formation on the paper P is started.

In other words, the decision process shown in steps S101 to S105 is performed before the feeding out of the paper P from the paper accommodating device 200 is started.

In a case where the input of the print job is performed to the image forming apparatus 1 after the decision process, gas blowing onto the paper bundle 54 by the blowing device 400 is resumed. Then, the feeding out of the paper P included in the paper bundle 54 is started, and the image formation on the paper P is started.

In a case where the input of the print job has been performed, the CPU 11a reads and acquires the above-described blowing setting stored in the secondary storage unit 91. Then, the CPU 11a controls the blowing device 400 based on the acquired blowing setting.

In this case, the blowing device 400 operates in accordance with the blowing setting decided on by the above-described decision process.

In a case where the print job has been input, the blowing device 400 blows gas onto the paper P in accordance with the blowing setting which is a predetermined setting.

In the present exemplary embodiment, in a case where the input of the print job is performed, gas blowing onto the paper P is resumed. Then, the feeding out of the paper P and the image formation on the paper P are started.

The processing of step S105 will be described in detail.

In step S105, the CPU 11a specifies the best paper image which is the paper image in which, for example, the floating state of the paper P is in the most preferable state, as described above. The CPU 11a specifies the best paper image from among the plurality of paper images stored in the secondary storage unit 91.

Then, the CPU 11a decides on the content of the blowing setting based on the blowing condition associated with the specified best paper image.

In the present exemplary embodiment, the CPU 11a performs the specification by using a trained model generated through machine learning in specifying the best paper image.

The CPU 11a specifies the best paper image from among the plurality of paper images by using the trained model generated through machine learning.

Then, the CPU 11a decides on the content of the blowing setting based on the blowing condition associated with the specified best paper image.

In the present exemplary embodiment, the trained model generated in advance is stored in the secondary storage unit 91. The CPU 11a specifies the best paper image from among the plurality of paper images by using the trained model.

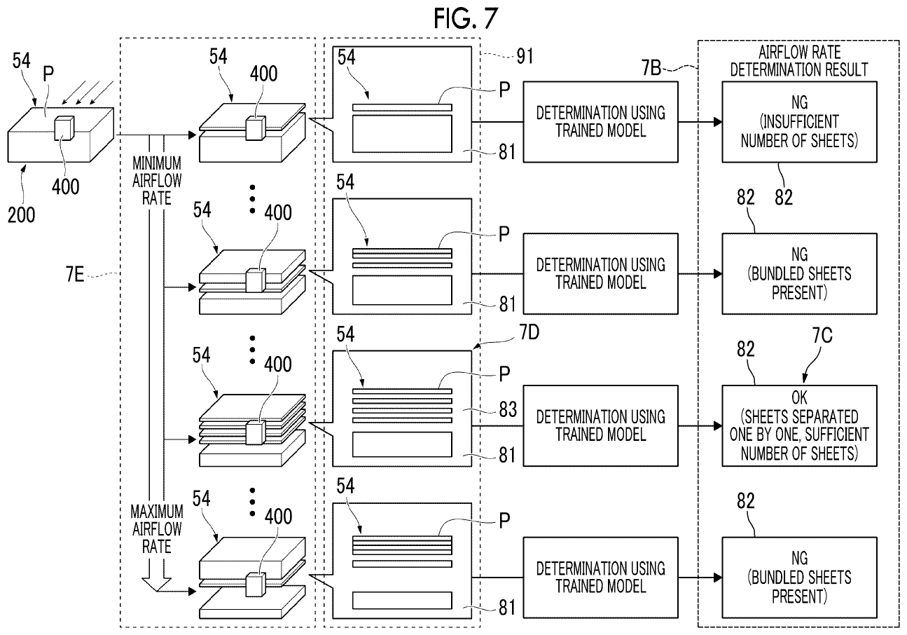

FIG. 7 is a diagram illustrating the processing of step S105.

In the present exemplary embodiment, a plurality of paper images 81 are stored in the secondary storage unit 91. In addition, although not shown, the secondary storage unit 91 also stores the blowing condition associated with each of the paper images 81.

In the processing of step S105, the CPU 11a generates floating state information 82 for each of the paper images 81, as indicated by reference numeral 7B, by using the trained model generated through machine learning.

The “floating state information 82” refers to information obtained for each of the paper images 81 and to information regarding the floating state of the paper bundle 54 shown in the paper image 81.

In the example shown in FIG. 7, the floating state information 82 indicated by reference numeral 7C is the floating state information 82 indicating that, for example, the floating state of the paper P is in the most preferable state.

In this case, the CPU 11a specifies the paper image 81 indicated by reference numeral 7D, which is the basis for obtaining the floating state information 82, as a best paper image 83. Then, the CPU 11a acquires the blowing condition (not shown) associated with the best paper image 83.

The CPU 11a acquires the blowing condition associated with the best paper image 83 indicated by reference numeral 7D from the secondary storage unit 91. Then, the CPU 11a decides on the content of the blowing setting based on the acquired blowing condition.

In specifying the best paper image 83, the CPU 11a generates the floating state information 82 for each of the paper images 81 as indicated by reference numeral 7B. In this case, a plurality of pieces of floating state information 82 are generated.

Then, the CPU 11a specifies the floating state information 82 indicating that, for example, the floating state of the paper P is in the most preferable state, from among the plurality of pieces of generated floating state information 82.

Next, the CPU 11a specifies the paper image 81, which is the basis for obtaining the specified floating state information 82, as the best paper image 83.

Then, the CPU 11a acquires the blowing condition associated with the best paper image 83. Then, the CPU 11a decides on the content of the blowing setting based on the acquired blowing condition.

The trained model will be described.

The trained model of the present exemplary embodiment is a trained model generated through machine learning using training data including an image of the paper bundle 54 that is in a state in which gas is being blown from the lateral side and information regarding the floating state of the paper bundle 54 shown in the image.

Hereinafter, in the present specification, the image of the paper bundle 54 used to generate the trained model will be referred to as a “model generation image”. Additionally, this information regarding the floating state of the paper bundle 54 used to generate the trained model may be referred to as “model generation information”.

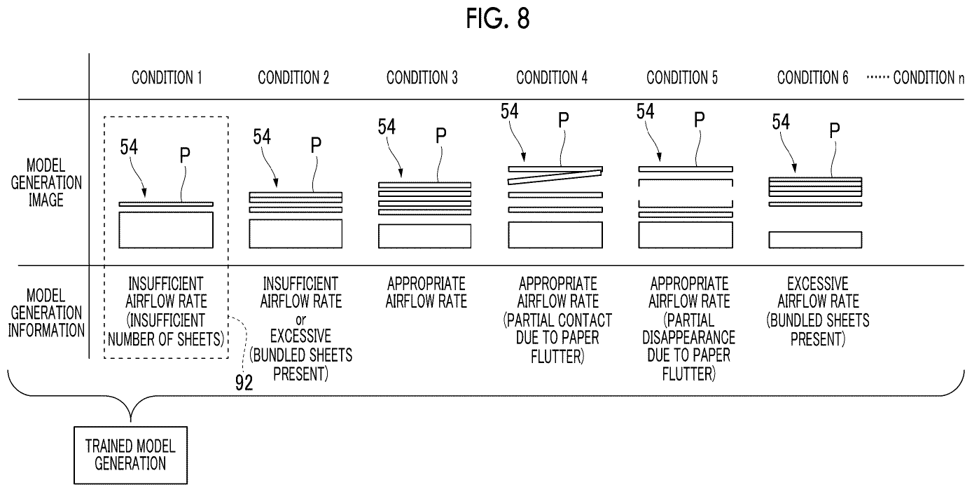

FIG. 8 is a diagram showing processing in a case of generating the trained model of the present exemplary embodiment.

In the present exemplary embodiment, a plurality of data pairs 92, each including the model generation image and the model generation information, are prepared in advance.

The model generation image is an image showing the paper bundle 54 that is in a state in which gas is being blown from the lateral side.

The model generation information is information indicating whether the floating of the paper bundle 54 shown in the model generation image is favorable or not. This information indicating whether the floating is favorable or not is information generated by a human.

In the present exemplary embodiment, a plurality of model generation images in which conditions at the time of generating the model generation image are different from each other are prepared as the model generation images.

Specifically, in the present exemplary embodiment, a plurality of types of paper P having different basis weights and different types of paper P are prepared in advance. Then, an image showing the paper bundle 54 composed of the sheets of paper P is acquired as the model generation image. In addition, in acquiring the model generation image, environmental conditions such as a temperature and a humidity are sequentially changed, and then the model generation image is acquired.

Further, in acquiring the model generation image, the airflow rate to be blown to the paper bundle 54 is sequentially changed, and then the model generation image is acquired.

Then, the model generation information including information indicating whether the floating is favorable or not is associated with the acquired model generation image.

Consequently, the plurality of data pairs 92, each including the model generation image and the model generation information, are generated.

In the present exemplary embodiment, the plurality of data pairs 92, each including the model generation image and the model generation information, are used as training data.

In the present exemplary embodiment, a computer (not shown) performs machine learning by using the plurality of data pairs 92 as the training data, thereby obtaining the trained model generated through machine learning.

In the present exemplary embodiment, the computer uses the plurality of data pairs 92 as the training data and performs so-called supervised learning, thereby obtaining the trained model.

The generation of the trained model may be performed by the CPU 11a provided in the image forming apparatus 1 or by another computer.

In a case where the generation of the trained model is performed by another computer, the trained model generated by the other computer is stored in the secondary storage unit 91 shown in FIG. 2.

The storage of the trained model in the secondary storage unit 91 may be performed in a manufacturing stage of the image forming apparatus 1.

Additionally, the trained model may also be provided to the image forming apparatus 1 by using a recording medium, such as a semiconductor memory, or communication means. After the provision, the trained model is stored in the secondary storage unit 91.

In the present exemplary embodiment, the generated trained model is stored in the secondary storage unit 91.

In step S105 described above, the CPU 11a generates, for each of the plurality of acquired paper images 81, the floating state information 82 indicated by reference numeral 7B in FIG. 7 by using the trained model generated in advance.

In the present exemplary embodiment, as shown in FIG. 7, the plurality of paper images 81 in which blowing conditions of gas are different from each other are acquired. In the present exemplary embodiment, the floating state information 82 for the paper image 81 is generated by using the trained model, for each of the plurality of acquired paper images 81.

The CPU 11a generates, for each of the plurality of acquired paper images 81, the floating state information 82 by using the trained model.

In the decision process described above, the CPU 11a operates the blowing device 400 under each of the plurality of blowing conditions different from each other, as indicated by reference numeral 7E in FIG. 7.

Then, the CPU 11a generates, for each paper image 81 obtained under each of the blowing conditions, the floating state information 82 by using the trained model.

Next, the CPU 11a decides on the above-described blowing setting based on the generated floating state information 82.

Specifically, as described above, the CPU 11a specifies the floating state information 82 indicating the most favorable floating state, from among the plurality of pieces of obtained floating state information 82.

Then, the CPU 11a specifies the paper image 81, which is the basis for the specified floating state information 82, as the best paper image 83.

Next, the CPU 11a reads and acquires the blowing condition associated with the specified best paper image 83, from the secondary storage unit 91.

Then, the CPU 11a decides on the content of the blowing setting based on the acquired blowing condition. The blowing setting whose content has been decided on is stored in the secondary storage unit 91.

Thereafter, in a case where the input of the print job is performed, the blowing setting stored in the secondary storage unit 91 is read. Then, the blowing device 400 operates under the blowing setting.

In the present exemplary embodiment, the content of the blowing setting is decided on by using the trained model in this way. In other words, in the present exemplary embodiment, the content of the blowing setting is decided on by using so-called AI.

In a case where the AI is used as in the present exemplary embodiment, the accuracy of the blowing setting may be enhanced as compared with a case where classical image processing without AI is used.

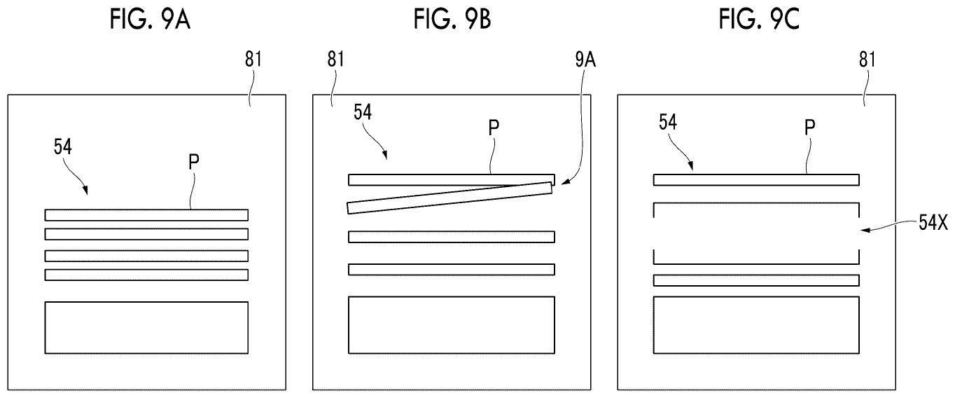

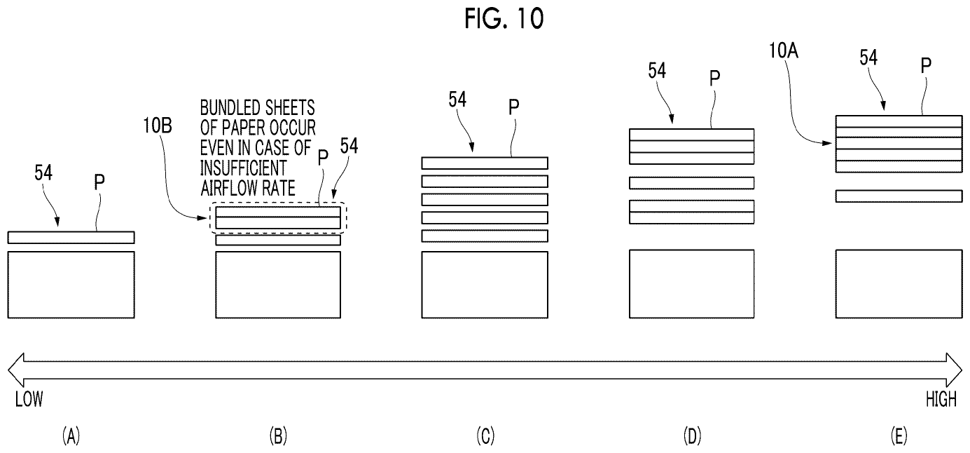

FIGS. 9A to 9C are diagrams showing the paper images 81 obtained by the imaging unit 500.

The paper P that is in a state in which gas is being blown is in a floating state while oscillating vertically.

In this case, the paper image 81 shown in FIG. 9B is obtained depending on a timing at which the imaging unit 500 performs imaging. In the paper image 81 shown in FIG. 9B, at a location indicated by reference numeral 9A, some of sheets of paper P are in contact with each other.

In this case, in a case where the paper image 81 shown in FIG. 9B is analyzed by using the classical image processing, determination may be made that overlapping between the sheets of paper P has occurred even in a situation in which, in reality, the sheets of paper P are likely to be spaced apart from each other. In other words, in this case, determination may be made that, for example, the floating state of the paper P is not in a preferable state.

In classical signal processing using threshold value determination, contour detection, and the like, flexible determination like a human cannot be made, and incorrect determinations are likely to occur.

In addition, the paper image 81 shown in FIG. 9C is obtained depending on the timing at which the imaging unit 500 performs imaging.

In the paper image 81 shown in FIG. 9C, the paper P is not shown in a middle portion 54X in a height direction of the paper bundle 54.

In the paper bundle 54, which is the basis for the paper image 81 shown in FIG. 9C, the paper P is actually present in the middle portion 54X.

However, in the paper image 81 shown in FIG. 9C, due to the momentary movement of the paper P or the like, the paper P is not shown in the middle portion 54X.

In this case, in a case where the classical signal processing is used, determination may be made that, for example, the floating state of the paper P is not in a preferable state.

On the other hand, in a case where the trained model generated through machine learning is used as in the present exemplary embodiment, for example, the floating state information 82 indicating a favorable floating state may be generated based on the paper image 81 shown in FIG. 9B or the paper image 81 shown in FIG. 9C.

Parts (A) to (E) in FIG. 10 are diagrams showing a state of the floating paper bundle 54.

Here, a case is considered in which AI is not used and, for example, feedback control is performed to set the blowing condition such that the most favorable floating state of the paper P is obtained.

In the feedback control, the state of the paper P under each of the blowing conditions is observed to determine, for example, whether or not the blowing condition is preferable.

In the feedback control, in a case where determination is made that, for example, the blowing condition is not preferable, the blowing condition is changed. Then, determination is made again, for example, as to whether or not the blowing condition is preferable.

Here, for example, in a case where the airflow rate is high, as indicated by reference numeral 10A in FIG. 10, overlapping between the sheets of paper P is likely to occur. In this case, in the feedback control, the airflow rate is determined to be high, and after the airflow rate is reduced, the state of the paper P is determined again.

Meanwhile, overlapping between the sheets of paper P may also occur even under a situation in which the airflow rate is low, as indicated by reference numeral 10B.

In a case where the sheets of paper P have a high degree of adhesion to each other, such as in a case where the paper P is coated paper, overlapping between the sheets of paper P may occur even under a situation in which the airflow rate is low.

In this case, in the feedback control, a situation may occur in which the state of the paper P is determined again after the airflow rate is reduced. Meanwhile, in this case, an upper surface of the paper bundle 54 is even lower than the state shown in the part (B) in FIG. 10. In this case, a problem occurs in which the floating amount of the paper P is insufficient.

An event in which the sheets of paper P overlap each other may occur under various conditions.

In a case where feedback control is performed to decide on, for example, a preferable blowing condition, the accuracy of the decided-on blowing condition may decrease. Alternatively, it takes time to decide on the blowing condition.

On the other hand, in a case where so-called AI is used as in the present exemplary embodiment, such a problem is less likely to occur.

### Others

As the trained model, another trained model different from the above may be used.

Another example of the other trained model includes a trained model generated through machine learning using training data including a model generation image obtained by the imaging unit 500 that is, for example, in a state in which powder has adhered.

In this case, the training data is composed of a data pair 92 including the model generation image obtained by the imaging unit 500 that is in a state in which powder has adhered, and the model generation information regarding the floating state of the paper bundle 54 shown in the model generation image.

The model generation image obtained by the imaging unit 500 that is in a state in which powder has adhered refers to an image of the paper bundle 54 that is in a state in which gas is being blown from the lateral side, the image being obtained by the imaging unit 500 that is in a state in which powder has adhered.

In this case, the CPU 11a generates the floating state information 82 by using the trained model generated through machine learning using the training data including the model generation image obtained by the imaging unit 500 that is in a state in which powder has adhered.

Here, an example of the powder that has adhered to the imaging unit 500 includes paper dust.

In this case, the CPU 11a generates the floating state information 82 by using the trained model generated through machine learning using the training data including the model generation image obtained by the imaging unit 500 that is in a state in which paper dust has adhered.

In a case where image formation is performed on the paper P by the image forming apparatus 1, paper dust generated from the paper P adheres to the imaging unit 500. In this case, the obtained paper image 81 is an image obtained by the imaging unit 500 to which paper dust has adhered.

In a case where the trained model generated through machine learning using the training data including the model generation image obtained by the imaging unit 500 that is in a state in which paper dust has adhered is used, the accuracy of generating the floating state information 82 may be further enhanced.

Additionally, the trained model may be further prepared for each type of paper P constituting the paper bundle 54.

In this case, as the model generation image showing the paper bundle 54, the model generation image for each of a plurality of types of paper bundles 54 having different types of paper P is prepared.

Then, as in the above description, each of the plurality of model generation images is associated with the model generation information including information indicating whether the floating is favorable or not.

Then, the trained model is generated by using training data including a plurality of data pairs 92, each including the model generation image and the model generation information.

In a case where the trained model is generated for each type of paper P, a learning model for each type of paper P is generated in this generation stage of the trained model.

Then, in this case, the generated trained model and the information regarding the type of paper P are stored in the secondary storage unit 91 in a state of being associated with each other.

In this case, in a case of performing the processing of step S105 described above, the CPU 11a first acquires type information which is information regarding the type of the paper P constituting the paper bundle 54 shown in the paper image 81.

In the present exemplary embodiment, the user inputs the type information. The user operates the receiving unit 70 to input the type information to the image forming apparatus 1. Consequently, the image forming apparatus 1 acquires the type information.

Alternatively, the type information may be acquired by a sensor (not shown) provided in the accommodating section 53. In this case as well, the image forming apparatus 1 acquires the type information.

In a case of performing the processing of step S105 described above, the CPU 11a first acquires the type information acquired by the image forming apparatus 1.

Then, the CPU 11a reads and acquires the trained model corresponding to the type specified by the acquired type information, from the secondary storage unit 91.

Then, the CPU 11a generates the floating state information 82 by using the trained model read and acquired from the secondary storage unit 91, for each of the paper images 81.

Then, as in the above description, the CPU 11a acquires the blowing condition associated with the best paper image 83 that is the paper image 81, which is the basis for the floating state information 82 indicating a most favorable state. Then, the CPU 11a decides on the content of the blowing setting based on the acquired blowing condition.

In addition, the CPU 11a may also obtain a plurality of paper images 81 under each of the blowing conditions, in operating the blowing device 400 under each of the above-described plurality of blowing conditions.

The CPU 11a may obtain 10 paper images 81, for example, under each of the blowing conditions. In this case, a plurality of paper images 81 are obtained under each of the blowing conditions.

Then, in this case, the CPU 11a uses the trained model to generate the floating state information 82 for each of the plurality of paper images 81 obtained under each of the blowing conditions. In this case, a plurality of pieces of floating state information 82 are generated under each of the blowing conditions.

Then, the CPU 11a decides on the content of the blowing setting based on the plurality of pieces of floating state information 82 generated under each of the blowing conditions.

Specifically, in this case, the CPU 11a obtains an average value of the plurality of pieces of floating state information 82 generated under each of the blowing conditions. In the present exemplary embodiment, the floating state information 82 is represented by a numerical value. In the present exemplary embodiment, for example, the more favorable the floating state of the paper P is, the greater the numerical value is.

The CPU 11a obtains the average value of the plurality of pieces of floating state information 82 generated under each of the blowing conditions.

A specific example will be described. As described above, in a case where 10 paper images 81 are obtained under each of the blowing conditions, and 10 pieces of floating state information 82 are obtained under each of the blowing conditions, the CPU 11a obtains an average value of the 10 pieces of floating state information 82.

Then, the CPU 11a decides on the content of the blowing setting based on the average value obtained under each of the blowing conditions.

Specifically, the CPU 11a specifies one average value of the average values obtained under the respective blowing conditions. More specifically, the CPU 11a specifies one average value having a greatest value among the average values obtained under the respective blowing conditions.

Then, the CPU 11a specifies 10 paper images 81 corresponding to the 10 pieces of floating state information 82, which are the basis for the one specified average value.

Then, the CPU 11a reads and acquires, from the secondary storage unit 91, the blowing condition that has been stored in the secondary storage unit 91 in association with the 10 paper images 81.

Then, the CPU 11a decides on the content of the blowing setting based on the blowing condition read and acquired from the secondary storage unit 91.

Additionally, the CPU 11a may also operate the blowing device 400 under each of a smaller number of blowing conditions in operating the blowing device 400 under each of the above-described plurality of blowing conditions different from each other.

Specifically, in operating the blowing device 400, the CPU 11a may operate the blowing device 400 under each of a smaller number of blowing conditions than a total number of all blowing conditions included in the above-described plurality of blowing conditions different from each other.

Here, for example, a case is assumed in which there are 20 blowing conditions, such as Condition 1 to Condition 20.

In a case of operating the blowing device 400 under each of a smaller number of blowing conditions than the total number, the CPU 11a operates the blowing device 400, for example, under only each of Condition 1, Condition 5, Condition 10, Condition 15, and Condition 20.

In this case, the CPU 11a operates the blowing device 400 under each of five blowing conditions, the number of which is less than 20, which is the total number of all the blowing conditions.

In the present specification, hereinafter, a smaller number of blowing conditions than the total number of all the blowing conditions may be referred to as a “small number of blowing conditions”.

Next, in this case, the CPU 11a sets another blowing condition in a case where the blowing device 400 is operated under the other blowing condition, based on respective pieces of floating state information 82 generated in correspondence with the small number of blowing conditions.

Then, the CPU 11a operates the blowing device 400 under the other blowing condition.

Specifically, the other blowing condition refers to blowing conditions other than Condition 1, Condition 5, Condition 10, Condition 15, and Condition 20 described above. The other blowing condition refers to blowing conditions other than the small number of blowing conditions.

In setting the other blowing condition, the CPU 11a first specifies the floating state information 82 indicating the most favorable floating state, among the respective pieces of floating state information 82 generated in correspondence with the above-described small number of blowing conditions.

A Specific example will be described. The CPU 11a specifies the floating state information 82 indicating the most favorable floating state, among the respective pieces of floating state information 82 generated in correspondence with Condition 1, Condition 5, Condition 10, Condition 15, and Condition 20.

Next, the CPU 11a specifies the blowing condition in a case where the floating state information 82 indicating the most favorable floating state is obtained.

In other words, the CPU 11a specifies the blowing condition in a case where the floating state information 82 indicating the most favorable floating state is obtained.

In specifying the blowing condition, the CPU 11a first specifies the paper image 81, which is the basis for the floating state information 82 indicating the most favorable floating state.

Next, the CPU 11a specifies the blowing condition associated with the specified paper image 81.

Consequently, the CPU 11a specifies the blowing condition in a case where the floating state information 82 indicating the most favorable floating state is obtained. Hereinafter, in the present specification, this blowing condition will be referred to as a “first blowing condition”.

A specific example will be described.

The first blowing condition, which is the blowing condition in a case where the floating state information 82 indicating the most favorable floating state is obtained, is any one of Condition 1, Condition 5, Condition 10, Condition 15, or Condition 20.

Here, for example, a case is assumed in which the floating state information 82 generated in correspondence with Condition 5 is the floating state information 82 indicating the most favorable floating state.

In this case, the CPU 11a specifies Condition 5 as the first blowing condition.

Next, the CPU 11a specifies the blowing condition in a case where the floating state information 82 indicating the second most favorable floating state is obtained, from among the small number of blowing conditions.

In this case, the CPU 11a first specifies the floating state information 82 indicating the second most favorable floating state, from among the plurality of pieces of obtained floating state information 82.

Next, the CPU 11a specifies the paper image 81, which is the basis for the floating state information 82 indicating the second most favorable floating state. Then, the CPU 11a specifies the blowing condition associated with the specified paper image 81.

Consequently, the CPU 11a specifies the blowing condition in a case where the floating state information 82 indicating the second most favorable floating state is obtained. Hereinafter, in the present specification, this blowing condition will be referred to as a “second blowing condition”.

A specific example will be described.

For example, a case is assumed in which the floating state information 82 generated in correspondence with Condition 10 is the floating state information 82 indicating the second most favorable floating state.

In this case, the CPU 11a specifies Condition 10 as the second blowing condition.

Next, the CPU 11a sets the above-described other condition based on the specified first blowing condition and the specified second blowing condition.

As described above, in a case where Condition 5 is the first blowing condition, and Condition 10 is the second blowing condition, the CPU 11a sets the above-described other condition based on Condition 5 and Condition 10.

Specifically, the CPU 11a sets, for example, a blowing condition located between the first blowing condition and the second blowing condition as the other blowing condition.

A specific example will be described. The CPU 11a sets at least one of Conditions 6 to 9, which are located between Condition 5 and Condition 10, as the other blowing condition.

Then, the CPU 11a operates the blowing device 400 under the other blowing condition.

Then, the CPU 11a obtains the paper image 81 for the paper bundle 54 onto which gas is being blown by the blowing device 400 that operates under the other blowing condition. Then, the CPU 11a acquires, for the paper image 81, the floating state information 82 by using the trained model used in step S105.

In the present specification, hereinafter, this floating state information 82 will be referred to as “other-condition state information”.

Next, the CPU 11a compares an other-condition state that is a state specified by the acquired other-condition state information with a first state that is a state specified by the floating state information 82 obtained in correspondence with the above-described first blowing condition.

In a case where the other-condition state is more favorable than the first state, the CPU 11a decides on the content of the blowing setting based on the above-described other blowing condition. More specifically, in this case, the CPU 11a sets, for example, the above-described other blowing condition as the blowing setting.

In addition, in a case where the first state is more favorable than the other-condition state, the CPU 11a decides on the content of the blowing setting based on the first blowing condition. More specifically, in this case, the CPU 11a sets, for example, the first blowing condition as the blowing setting.

Here, in a case where the blowing device 400 is operated under only the blowing conditions included in the small number of blowing conditions, the blowing condition under which the most favorable floating state of the paper bundle 54 is obtained cannot be specified.

The condition under which the most favorable floating state is obtained is not necessarily the above-described first blowing condition, and may be other conditions close to the first blowing condition.

Therefore, in this processing example, as described above, the other-condition state information regarding the other blowing condition located between the first blowing condition and the second blowing condition is also acquired.

Then, the other-condition state specified by the other-condition state information corresponding to the other blowing condition is compared with the first state specified by the floating state information 82 corresponding to the first blowing condition. Then, the blowing setting is decided on based on the result of the comparison.

In a case where the blowing device 400 is operated under the small number of blowing conditions and the above-described other blowing condition, the decision process may be performed in a shorter time as compared with a case where the blowing device 400 is operated under all of the blowing conditions.

In a case where the blowing device 400 is operated under the above-described other blowing condition located between the first blowing condition and the second blowing condition, the blowing device 400 may be operated under all of the other blowing conditions.

Specifically, for example, the blowing device 400 may be operated under each of all of Condition 6 to Condition 9 located between Condition 5 and Condition 10 described above.

In this case, the other-condition state information indicating the most favorable floating state is specified from among a plurality of pieces of other-condition state information obtained in correspondence with the plurality of other blowing conditions.

Then, the other-condition state that is a state specified by the specified other-condition state information is compared with the first state that is a state specified by the floating state information 82 obtained in correspondence with the first blowing condition.

Then, in this case, as in the above description, in a case where the other-condition state is more favorable than the first state, the blowing setting is decided on based on the blowing condition corresponding to the other-condition state.

Additionally, in a case where the first state is more favorable than the other-condition state, the blowing setting is decided on based on the first blowing condition corresponding to the first state.

In addition, only one of the above-described plurality of other blowing conditions may be selected, and the blowing device 400 may be operated under only the one other blowing condition.

A specific example will be described. Only one condition may be selected from among Condition 6 to Condition 9 described above, and the blowing device 400 may be operated under only the one condition.

In a case where only one of the plurality of other blowing conditions is selected, for example, the other blowing condition corresponding to a median value among the plurality of other blowing conditions is selected.

In a case where the number of the plurality of other blowing conditions is an even number, one of two other blowing conditions corresponding to the median value is selected in accordance with a predetermined selection criterion.

In this case, one piece of other-condition state information corresponding to one other blowing condition is acquired.

Then, in this case, the other-condition state specified by the acquired one piece of other-condition state information is compared with the first state specified by the floating state information 82 obtained in correspondence with the first blowing condition.

Then, as in the above description, in a case where the other-condition state is more favorable than the first state, the blowing setting is decided on based on the other blowing condition.

Additionally, in a case where the first state is more favorable than the other-condition state, the blowing setting is decided on based on the first blowing condition.

Another processing example will be described.

In another processing example, the paper information that is information regarding the paper P accommodated in the accommodating section 53 and the above-described blowing setting that is decided on for the paper P are stored in the secondary storage unit 91 in a state of being associated with each other.

In the present exemplary embodiment, in a case where the paper P is accommodated in the accommodating section 53, paper information that is information regarding the paper P to be accommodated in the accommodating section 53 is input by the user.

Specifically, the user operates the receiving unit 70 to input the paper information. The user inputs, for example, information regarding the type of paper or information regarding the size of the paper P as the paper information.

In response to this input, the CPU 11a acquires the paper information.

Thereafter, the decision process shown in FIG. 6 is performed, and the blowing setting for the paper P accommodated in the accommodating section 53 is decided on.

Then, in this processing example, the CPU 11a stores the acquired paper information and the decided-on content of the blowing setting in the secondary storage unit 91 in a state of being associated with each other.

In this case, the CPU 11a stores the paper information that is information regarding the paper bundle 54 shown in the paper image 81 shown in FIG. 7 and the blowing condition set as the blowing setting in the secondary storage unit 91 in a state of being associated with each other.

Then, in this processing example, in a case where the new paper P is accommodated in the accommodating section 53 thereafter, the CPU 11a acquires the paper information newly input by the user.

In other words, in a case where the paper bundle 54 is newly installed by the user, the CPU 11a acquires the paper information newly input by the user.

Then, the CPU 11a determines whether paper information that matches the newly input paper information has been stored in the secondary storage unit 91.

In this case, the CPU 11a determines whether the paper information that matches the paper information regarding the newly installed paper bundle 54 has been stored in the secondary storage unit 91 which is an information storage unit.

The CPU 11a performs a search process on the information stored in the secondary storage unit 91.

The CPU 11a performs the search process to determine whether the paper information that matches the paper information regarding the newly installed paper bundle 54 has been stored in the secondary storage unit 91.

Then, in a case where the CPU 11a determines that the paper information that matches the paper information regarding the newly installed paper bundle 54 has been stored in the secondary storage unit 91, the CPU 11a reads and acquires the blowing setting stored in the secondary storage unit 91.

In this case, the CPU 11a reads and acquires, from the secondary storage unit 91, the blowing setting that has been stored in the secondary storage unit 91 in association with the matching paper information.

Then, the CPU 11a operates the blowing device 400 under the read and acquired blowing setting. Consequently, gas is blown onto the paper P newly accommodated in the accommodating section 53. In other words, gas is blown onto the newly installed paper P.

In a case where the paper information that matches the paper information regarding the newly accommodated paper P has been stored in the secondary storage unit 91, the CPU 11a specifies the blowing condition that has been stored in the secondary storage unit 91 and that has been associated with the paper information.

Then, the CPU 11a reads and acquires the specified blowing condition from the secondary storage unit 91.

Next, the CPU 11a decides on the blowing condition for the blowing device 400 in a case where the feeding out of the paper P included in the newly accommodated paper bundle 54 is to be performed, based on the acquired blowing condition. In other words, the CPU 11a decides on the content of the blowing setting in a case where the feeding out of the paper P included in the newly accommodated paper bundle 54 is to be performed.

Thereafter, the blowing device 400 operates under the blowing setting. Consequently, gas is blown onto the new paper P.

Then, the CPU 11a acquires the paper image 81 of the new paper P for which gas blowing has been started.

Next, the CPU 11a acquires the floating state information 82 for the paper image 81. The CPU 11a uses the trained model used in step S105 to acquire the floating state information 82 for the paper image 81.

Then, the CPU 11a determines whether the acquired floating state information 82 is, for example, information indicating the favorable floating state.

Then, in a case where the acquired floating state information 82 is, for example, information indicating the favorable floating state, the CPU 11a finally decides on the above-described blowing condition read and acquired from the secondary storage unit 91, as the blowing setting for the above-described new paper P.

On the other hand, in a case where the floating state information 82 acquired for the new paper P is not, for example, information indicating the favorable floating state, the CPU 11a performs the decision process shown in FIG. 6 from step S101 to decide on the new blowing setting.

In addition, a case is also assumed in which the paper information that matches the paper information newly input by the user is not stored in the secondary storage unit 91. In this case as well, the CPU 11a performs the decision process shown in FIG. 6 from step S101 to decide on the new blowing setting.

In a case where this processing is performed using the blowing setting read and acquired from the secondary storage unit 91, the decision process for deciding on the content of the blowing setting may be performed in a shorter time.

In a case where the paper information that matches the paper information newly input by the user is stored in the secondary storage unit 91, the decision process shown in FIG. 6 does not need to be performed from step S101. In other words, in this case, the floating state information 82 does not need to be generated for all of the blowing conditions set in advance.

In this case, the decision process for deciding on the content of the blowing setting may be performed in a shorter time as compared with a case where the floating state information 82 is generated for all of the blowing conditions.

In some cases, the user may use only a limited type of paper P without using various types of paper P. In this case, the blowing setting read and acquired from the secondary storage unit 91 is used, and the time required to decide on the blowing setting is shortened.

In a configuration in which the blowing setting read and acquired from the secondary storage unit 91 is not used, the floating state information 82 is generated for all of the blowing conditions each time new paper P is accommodated in the accommodating section 53.

On the other hand, in a configuration in which the blowing setting read and acquired from the secondary storage unit 91 is used, the generation of the floating state information 82 for all of the blowing conditions is not required.

In a case where the paper P newly accommodated in the accommodating section 53 is a new type of paper P, the floating state information 82 is generated for all of the blowing conditions.

Additionally, even in a case where the temperature, the humidity, or the like around the image forming apparatus 1 has changed as compared with before, the floating state information 82 may be generated for all of the blowing conditions.

In a case where the temperature, the humidity, or the like has changed, a situation may occur in which the blowing setting read and acquired from the secondary storage unit 91 does not match the newly accommodated paper P.

Even in a case where the type of the newly accommodated paper P is the same as the type of the previous paper P, a situation may occur in which the blowing setting read and acquired from the secondary storage unit 91 does not match the newly accommodated paper P in a case where the temperature, the humidity, or the like has changed.

In a case where the temperature, the humidity, or the like has changed, a situation may occur in which the floating state information 82 acquired for the new paper P is not, for example, information indicating the favorable floating state.

In this case, the floating state information 82 is generated for all of the blowing conditions. Then, the new blowing setting is set based on the generated floating state information 82.

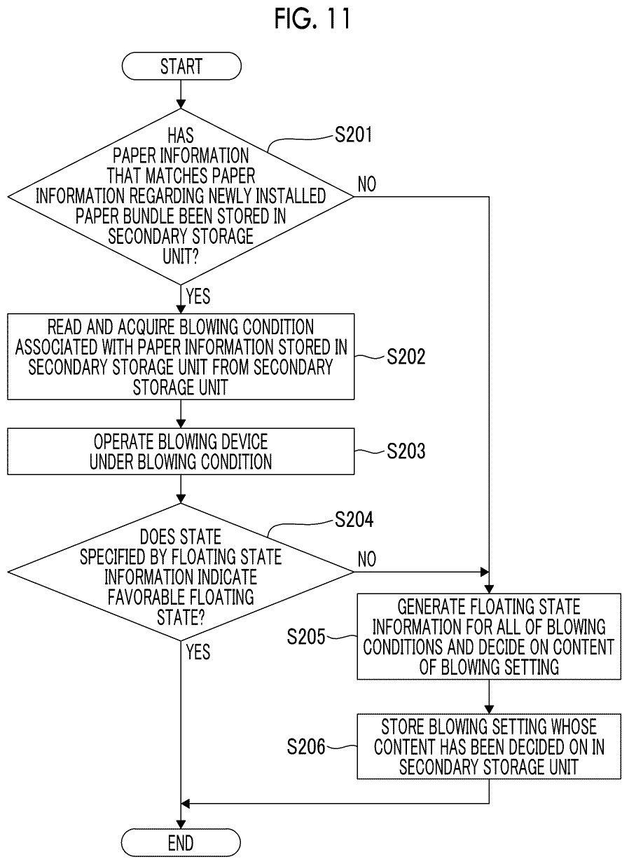

FIG. 11 is a flowchart showing a flow of the above-described processing of reading and acquiring the blowing setting.

In this processing, first, the CPU 11a acquires the paper information regarding the newly installed paper bundle 54. Then, the CPU 11a determines whether paper information that matches the paper information regarding the newly installed paper bundle 54 has been stored in the secondary storage unit 91 (step S201).

In step S201, in a case where determination is made that the matching paper information has been stored in the secondary storage unit 91, the process proceeds to step S202.

In step S202, the CPU 11a reads and acquires the blowing condition associated with the paper information stored in the secondary storage unit 91 from the secondary storage unit 91.

Then, the CPU 11a decides on the blowing condition read and acquired from the secondary storage unit 91 as the blowing setting.

Next, the CPU 11a operates the blowing device 400 under the blowing condition decided on as the blowing setting (step S203).

Next, the CPU 11a obtains the paper image 81 for the above-described new paper P, onto which gas is being blown by the blowing device 400 that has started operating. The CPU 11a further obtains the floating state information 82 for the paper image 81.

Then, the CPU 11a determines whether the state specified by the floating state information 82 indicates, for example, a favorable floating state (step S204).

Then, in a case where the CPU 11a determines that the state specified by the floating state information 82 indicates, for example, a favorable floating state, the CPU 11a sets the blowing condition read in step S202 without any change as the final blowing setting.

On the other hand, in step S201, in a case where determination is not made that the matching paper information has been stored in the secondary storage unit 91, the process proceeds to step S205.

In addition, in step S204, even in a case where determination is not made that the state specified by the floating state information 82 indicates, for example, a favorable floating state, the process proceeds to step S205.

In step S205, the same processing as the processing of steps S101 to S105 shown in FIG. 6 is performed.

That is, in step S205, processing of generating the floating state information 82 for all of the blowing conditions is performed. Further, in step S205, the content of the blowing setting is decided on based on the floating state information 82 for all of the blowing conditions.

Thereafter, in step S206, the blowing setting whose content has been decided on is stored in the secondary storage unit 91.

Another processing example will be further described.

Here, a processing example in a case where paper P in which folding has occurred, such as paper P with a folded corner, is accommodated in the accommodating section 53 will be described. In this processing example, in a case where the paper P in which folding has occurred is accommodated in the accommodating section 53, a warning is issued to the user.

In this processing example, at the time of generating the floating state information 82 for each paper image 81, information regarding the presence or absence of folding of the paper P is also generated in addition to the floating state information 82.

In a case where this processing is performed, an image of the paper P in which folding has occurred is also included in the training data at the time of generating the above-described trained model.

In a case where this processing is performed, as the model generation image, a model generation image for the paper bundle 54 composed of the paper P in which no folding has occurred and a model generation image for the paper bundle 54 including the paper P in which folding has occurred are prepared.

Additionally, in this case, model generation information including information indicating that folding has occurred and information regarding the floating state of the paper P is associated with the model generation image for the paper bundle 54 including the paper P in which folding has occurred.

Further, in this case, model generation information including information indicating that no folding has occurred and information regarding the floating state of the paper P is associated with the model generation image for the paper bundle 54 not including the paper P in which folding has occurred.

Then, as in the above description, a trained model is generated by causing the computer to perform supervised learning based on these pieces of information.

As a result, the trained model in this case is a trained model generated through machine learning using training data including the image of the paper bundle 54 that is in a state in which gas is being blown from the lateral side and the information regarding the floating state and the folded state.

Here, the floating state refers to a floating state of the paper bundle 54 shown in the image of the paper bundle 54 that is in a state in which gas is being blown from the lateral side.

In addition, the folded state refers to a folded state of the paper P constituting the paper bundle 54 shown in the image of the paper bundle 54 that is in a state in which gas is being blown from the lateral side.

Then, at the time of generating the floating state information 82 for each paper image 81, the floating state information 82 is generated by using the trained model.

In this case, information regarding the presence or absence of folding of the paper P is also generated for each paper image 81, in addition to the floating state information 82. In a case where folding has occurred in the paper P, information indicating that the paper P has a fold is also generated.

In this processing example, the CPU 11a uses the trained model to generate information regarding the floating state of the paper bundle 54 shown in the acquired paper image 81 and information regarding the folded state of the paper P constituting the paper bundle 54.

In a case where folding has occurred in the paper P, information indicating that the paper P has a fold is generated as the information regarding the folded state of the paper P.

In a case where the information indicating that the paper P has a fold is generated, the CPU 11a stops the decision process. Additionally, in this case, the CPU 11a notifies the user that the paper P in which folding has occurred is present, through the receiving unit 70.

This notification is not limited to a notification through the screen and may be a notification using sound. In other words, this notification is not limited to the notification through the screen and may be a notification using a speaker provided in the receiving unit 70 or the like.

On the other hand, in a case where the information indicating that the paper P has a fold is not generated, the CPU 11a decides on the content of the blowing setting by using the same method as the method described above.

Here, in a case where the paper bundle 54 includes the paper P in which folding has occurred, the double feeding of the paper P or the conveyance failure of the paper P is likely to occur. In a case where the paper P in which folding has occurred is included, notifying the user that the paper P in which folding has occurred is present makes the double feeding of the paper P or the conveyance failure of the paper P less likely to occur.

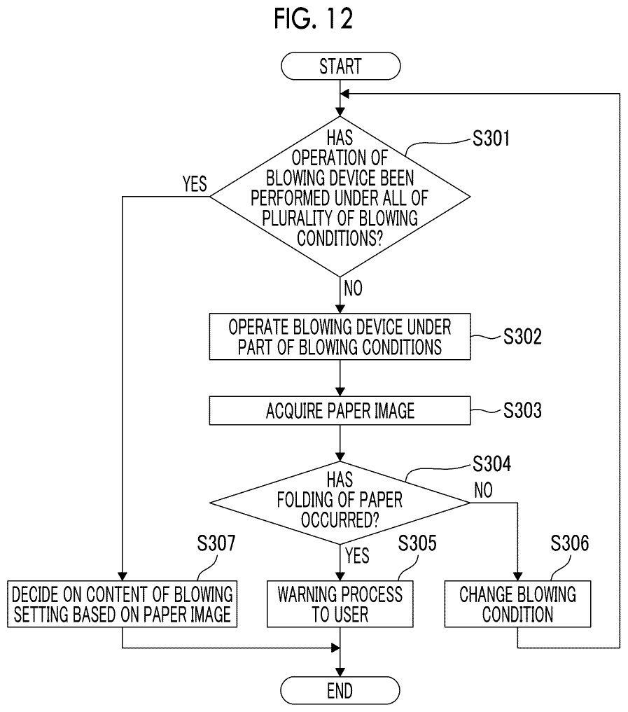

FIG. 12 is a flowchart showing a flow of the above-described processing in consideration of paper folding.

In this processing, first, processing of step S301 is performed. The processing of step S301 is the same as the processing of step S101 described above.

In step S301, determination is made as to whether the operation of the blowing device 400 has been performed under all of the plurality of blowing conditions.

In a case where determination is not made in step S301 that the operation of the blowing device 400 has been performed under all of the plurality of blowing conditions, the process proceeds to step S302.

In step S302, the CPU 11a operates the blowing device 400 under a part of the blowing conditions included in the plurality of blowing conditions, as in step S102 described above.

Consequently, the paper P constituting the paper bundle 54 is floated.

Next, the CPU 11a acquires the paper image 81 (step S303).

In step S303, the CPU 11a images the paper bundle 54. The CPU 11a operates the imaging unit 500 to image the paper bundle 54. As a result, the paper image 81 is acquired.

Next, the CPU 11a generates the floating state information 82 by using the acquired paper image 81 and the above-described trained model. In this case, the CPU 11a also generates information regarding the folded state of the paper P by using the acquired paper image 81 and the above-described trained model.

Then, the CPU 11a determines whether folding has occurred in the paper P, based on the information regarding the folded state (step S304).

In a case where the CPU 11a determines in step S304 that folding has occurred in the paper P, the CPU 11a performs a warning process to the user (step S305). In the warning process, as described above, the user is notified, through the receiving unit 70 or the speaker, that the paper P in which folding has occurred is present.

On the other hand, in a case where the CPU 11a does not determine in step S304 that folding has occurred in the paper P, the CPU 11a changes the blowing condition (step S306).

Consequently, the airflow rate of the gas to be blown to the paper bundle 54 is changed.

Thereafter, in step S301, determination is made again as to whether the operation of the blowing device 400 has been performed under all of the plurality of blowing conditions.

Then, in a case where determination is not made that the operation of the blowing device 400 has been performed under all of the plurality of blowing conditions, the processing after step S302 is performed again.

On the other hand, in a case where determination is made that the operation of the blowing device 400 has been performed under all of the plurality of blowing conditions, the processing of step S307 is executed.

The processing of step S307 is the same as the processing of step S105 described above. In step S307, the content of the blowing setting is decided on based on the plurality of obtained paper images 81.

Another processing example will be described.

Here, a processing example in which a trained model to be used is switched in a case where the number of sheets of paper P in the accommodating section 53 is small will be described. In other words, here, a processing example in a case where a learning model to be used is switched in accordance with the number of sheets of paper P in the accommodating section 53 will be described.

In this processing example, in a case where the decision process described above is performed, the CPU 11a determines whether the number of sheets of paper P is small, based on an output from the sensor (not shown).

Specifically, the CPU 11a determines whether the number of sheets of paper P in the accommodating section 53 is small, based on an output from a sensor (not shown) provided in the accommodating section 53.

In a case where the CPU 11a does not determine that the number of sheets of paper P is small, the CPU 11a generates the floating state information 82 for each of the obtained paper images 81 by using a trained model corresponding to a state in which the number of sheets of paper P is large.

More specifically, in a case where the CPU 11a does not determine that the number of sheets of paper P is less than a predetermined threshold value, the CPU 11a generates the floating state information 82 for each of the paper images 81 by using the trained model corresponding to a state in which the number of sheets of paper P is large.

In addition, in a case where the CPU 11a determines that the number of sheets of paper P is small, the CPU 11a generates the floating state information 82 for each of the obtained paper images 81 by using a trained model corresponding to a state in which the number of sheets of paper P is small.

More specifically, in a case where the CPU 11a determines that the number of sheets of paper P is less than the above-described predetermined threshold value, the CPU 11a generates the floating state information 82 for each of the paper images 81 by using a trained model corresponding to a state in which the number of sheets of paper P is small.

In a case where this processing is performed, a plurality of trained models corresponding to the respective numbers of sheets of paper P are prepared in advance.

In a case where the trained model is generated, for example, the trained model is first generated by using the model generation image of the paper bundle 54 that is in a state in which the number of sheets of paper P is large and the model generation information.

More specifically, in this case, the trained model is generated by using the model generation image of the paper bundle 54 that is in a state in which the number of sheets of paper P is greater than the above-described predetermined threshold value and the model generation information.

Additionally, a trained model is generated by using the model generation image of the paper bundle 54 that is in a state in which the number of sheets of paper P is small and the model generation information.

More specifically, the trained model is generated by using the model generation image of the paper bundle 54 that is in a state in which the number of sheets of paper P is less than the above-described predetermined threshold value and the model generation information.

In this processing example, the two types of generated trained models are stored in the secondary storage unit 91.

That is, the trained model based on the model generation image of the paper bundle 54 that is in a state in which the number of sheets of paper P is small and the trained model based on the model generation image of the paper bundle 54 that is in a state in which the number of sheets of paper P is large are stored in the secondary storage unit 91.

In this processing example, at least a first trained model and a second trained model are prepared as the trained models.

The first trained model is the above-described trained model based on the model generation image of the paper bundle 54 that is in a state in which the number of sheets of paper P is small.

The first trained model is a trained model generated through machine learning using training data including the image of the paper bundle 54 in which the number of sheets of paper P is less than the predetermined threshold value and onto which gas is being blown from the lateral side, and the model generation information.

The second trained model is the above-described trained model based on the model generation image of the paper bundle 54 that is in a state in which the number of sheets of paper P is large.

The second trained model is a trained model generated through machine learning using training data including the image of the paper bundle 54 in which the number of sheets of paper P is greater than the above-described predetermined threshold value and onto which gas is being blown from the lateral side, and the model generation information.

In this processing example, the CPU 11a acquires sheet count information which is information regarding the number of sheets of paper P constituting the paper bundle 54 shown in the paper image 81.

In a case where the number of sheets specified by the sheet count information is less than the above-described predetermined threshold value, the CPU 11a generates the floating state information 82 for the paper bundle 54 shown in the acquired paper image 81 by using the first trained model.

In addition, in a case where the number of sheets specified by the sheet count information is greater than the above-described predetermined threshold value, the CPU 11a generates the floating state information 82 for the paper bundle 54 shown in the acquired paper image 81 by using the second trained model.

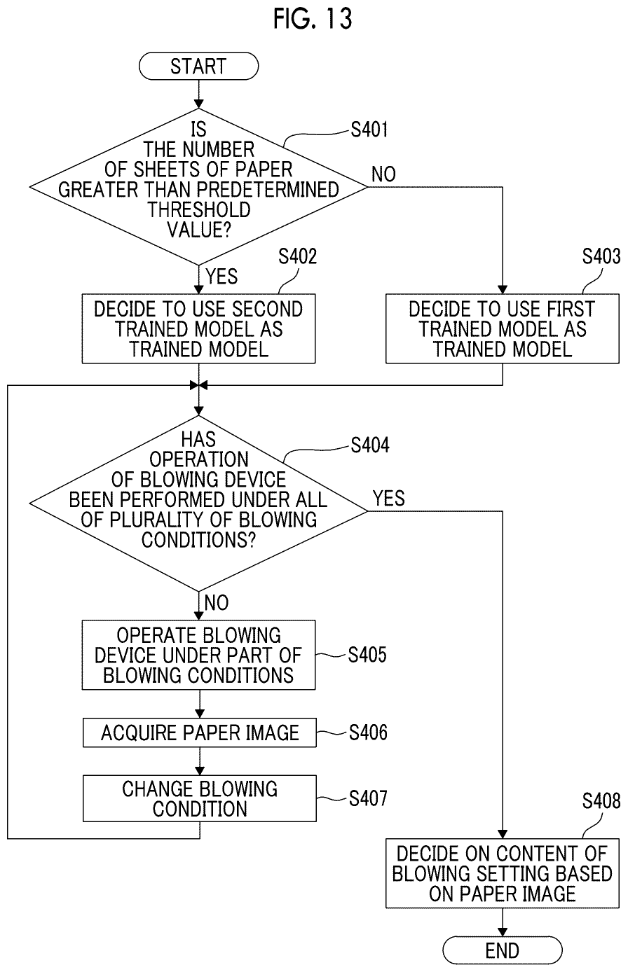

FIG. 13 is a flowchart showing a flow of the above-described processing of switching trained models in accordance with the number of sheets of paper P.

In this processing example, first, the CPU 11a acquires information regarding the number of sheets of paper P accommodated in the accommodating section 53 based on the output from the sensor (not shown). Then, the CPU 11a determines whether the number of sheets specified by this information is greater than the above-described predetermined threshold value (step S401).

Then, in a case where the CPU 11a determines in step S401 that the number of sheets specified by this information is greater, the CPU 11a decides to use the above-described second trained model as the trained model (step S402).

On the other hand, in a case where the CPU 11a does not determine in step S401 that the number of sheets specified by this information is greater, the CPU 11a decides to use the above-described first trained model as the trained model (step S403).

Thereafter, the CPU 11a performs the processing of steps S404 to S408. The processing of steps S404 and S408 are the same as the processing of steps S101 and S105 described above.

In the processing of step S408, the trained model is used.

In step S402, in a case where the use of the second trained model is decided on, the second trained model is used in step S408.

Additionally, in step S403, in a case where the use of the first trained model is decided on, the first trained model is used in step S408.

### Other Configuration Example of Apparatus

In the above description, the image forming apparatus 1 provided with the image forming section 1A has been described.

The configurations and the processing described above can also be applied to an apparatus that does not include the image forming section 1A.

The configurations and the processing described above can also be applied to an apparatus that does not include the image forming section 1A and that is provided with the paper accommodating device 200 as a core unit. The configurations and the processing described above can also be applied to an apparatus having only a paper feeding function.

The apparatus having only the paper feeding function is an apparatus that includes the paper accommodating device 200 and the control unit 240 as core units.

The present disclosure has been described above. The present disclosure can also be applied to a program and a program product.

### Supplementary Notes

(((1)))
An information processing system comprising:
a processor configured to:
   acquire a medium image that is an image of a bundle of recording media consisting of a plurality of recording media, the bundle of recording media being in a state in which gas is being blown from a lateral side of the recording media; and
   generate information regarding a floating state of the bundle of recording media shown in the acquired medium image by using a trained model generated through machine learning using training data including an image of a bundle of recording media that is in a state in which gas is being blown from a lateral side and information regarding a floating state of the bundle of recording media shown in the image.
(((2)))
The information processing system according to (((1))),
wherein the trained model is a trained model generated through machine learning using training data including an image of a bundle of recording media that is in a state in which gas is being blown from a lateral side and information indicating whether floating of the bundle of recording media shown in the image is favorable or not, and
the processor is configured to:
   use the trained model to generate information indicating whether floating of the bundle of recording media shown in the acquired medium image is favorable or not.
(((3)))
The information processing system according to (((1))) or (((2))),
wherein the trained model is a trained model generated through machine learning using training data including an image of a bundle of recording media that is in a state in which gas is being blown from a lateral side, the image being obtained by an imaging unit that is in a state in which powder has adhered, and information regarding a floating state of the bundle of recording media shown in the image, and
the processor is configured to:
   generate the information regarding the floating state of the bundle of recording media shown in the acquired medium image by using the trained model generated through machine learning using the training data including the image obtained by the imaging unit that is in a state in which powder has adhered.
(((4)))
The information processing system according to (((3))),
wherein the powder that has adhered to the imaging unit is paper dust, and
the processor is configured to:
   generate the information regarding the floating state of the bundle of recording media shown in the acquired medium image by using the trained model generated through machine learning using the training data including the image obtained by the imaging unit that is in a state in which the paper dust has adhered.
(((5)))
The information processing system according to any one of (((1))) to (((4))),
wherein the trained model is prepared for each type of recording medium constituting the bundle of recording media, and
the processor is configured to:
   acquire type information that is information regarding a type of recording medium constituting the bundle of recording media shown in the medium image; and
   generate the information regarding the floating state of the bundle of recording media shown in the acquired medium image by using the trained model corresponding to the type specified by the type information.
(((6)))
The information processing system according to any one of (((1))) to (((5))),
wherein the processor is configured to:
   acquire a plurality of medium images in which blowing conditions of gas are different from each other; and
   use the trained model to generate, for each of the plurality of acquired medium images, the information regarding the floating state of the bundle of recording media shown in the medium image.
(((7)))
The information processing system according to (((6))),
wherein the trained model is a trained model generated through machine learning using training data including an image of a bundle of recording media that is in a state in which gas is being blown from a lateral side and information indicating whether floating of the bundle of recording media shown in the image is favorable or not, and
the processor is configured to:
   use the trained model to generate, for each of the plurality of acquired medium images, information indicating whether floating of the bundle of recording media shown in the medium image is favorable or not.
(((8)))

The information processing system according to any one of (((1))) to (((7))), wherein the processor is configured to:
operate a blowing device that blows gas onto the bundle of recording media under each of a plurality of conditions different from each other, and use the trained model to generate, for each medium image obtained under each of the conditions, state information that is information regarding the floating state of the bundle of recording media shown in the medium image.
(((9)))
The information processing system according to (((8))), wherein the processor is configured to:
in operating the blowing device under each of the plurality of conditions, obtain a plurality of medium images under each of the conditions;
use the trained model to generate, for each of the plurality of medium images obtained under each of the conditions, the state information that is information regarding the floating state of the bundle of recording media shown in the medium image; and
set a blowing condition of the blowing device in a case where feeding out of a recording medium is to be performed, based on a plurality of pieces of state information generated under each of the conditions.
(((10)))
The Information Processing System According to (((8))), Wherein the Processor Is configured to:
in operating the blowing device under each of the plurality of conditions different from each other, operate the blowing device under each of a smaller number of conditions than a total number of all conditions included in the plurality of conditions, and set another condition in a case of operating the blowing device under the other condition, based on respective pieces of state information generated in correspondence with the smaller number of conditions.
(((11)))
The information processing system according to (((10))), wherein the processor is configured to:
set the other condition, based on a condition for operating the blowing device in a case where state information indicating a most favorable floating state is obtained, among the respective pieces of state information generated in correspondence with the smaller number of conditions.
(((12)))

The information processing system according to (((11))), wherein the processor is configured to:
set, as the other condition, a condition between the condition for operating the blowing device in a case where the state information indicating the most favorable floating state is obtained and a condition for operating the blowing device in a case where state information indicating a second most favorable floating state is obtained, among the respective pieces of state information generated in correspondence with the smaller number of conditions.
(((13)))
The information processing system according to (((1))), wherein the processor is configured to:
operate a blowing device that blows gas onto the bundle of recording media shown in the medium image under each of a plurality of conditions different from each other;
use the trained model to generate, for each medium image obtained under each of the conditions, state information that is information regarding the floating state of the bundle of recording media shown in the medium image;
set a blowing condition of the blowing device in a case where feeding out of a recording medium included in the bundle of recording media shown in the medium image is to be performed, based on the state information generated under each of the conditions;
store medium information that is information regarding the bundle of recording media shown in the medium image and the set blowing condition in an information storage unit in a state of being associated with each other; and
in a case where medium information that matches medium information regarding a newly installed bundle of recording media has been stored in the information storage unit, decide on a blowing condition of the blowing device in a case where feeding out of a recording medium included in the newly installed bundle of recording media is to be performed, based on the blowing condition associated with the medium information stored in the information storage unit.
(((14)))
The information processing system according to (((1))),
wherein the trained model is a trained model generated through machine learning using training data including an image of a bundle of recording media that is in a state in which gas is being blown from a lateral side, and information regarding a floating state of the bundle of recording media shown in the image and a folded state of a recording medium constituting the bundle of recording media shown in the image, and
the processor is configured to:
   use the trained model to generate the information regarding the floating state of the bundle of recording media shown in the acquired medium image and information regarding a folded state of a recording medium constituting the bundle of recording media shown in the medium image.
(((15)))
The information processing system according to (((1))),
wherein at least a first trained model and a second trained model are prepared as the trained model,
the first trained model is a trained model generated through machine learning using training data including an image of a bundle of recording media in which the number of recording media constituting the bundle of recording media is less than a predetermined threshold value, the bundle of recording media being in a state in which gas is being blown from a lateral side, and information regarding a floating state of the bundle of recording media shown in the image,
the second trained model is a trained model generated through machine learning using training data including an image of a bundle of recording media in which the number of recording media constituting the bundle of recording media is greater than the predetermined threshold value, the bundle of recording media being in a state in which gas is being blown from a lateral side, and information regarding a floating state of the bundle of recording media shown in the image, and
the processor is configured to:
   acquire sheet count information that is information regarding the number of recording media constituting the bundle of recording media shown in the medium image;
   in a case where the number specified by the sheet count information is less than the predetermined threshold value, use the first trained model to generate the information regarding the floating state of the bundle of recording media shown in the acquired medium image; and
   in a case where the number specified by the sheet count information is greater than the predetermined threshold value, use the second trained model to generate the information regarding the floating state of the bundle of recording media shown in the acquired medium image.
(((16)))
A recording medium accommodating device comprising:
an accommodating section that accommodates a plurality of recording media;
a blowing device that blows gas onto the recording media accommodated in the accommodating section; and
an information processing system that processes information regarding the recording media accommodated in the accommodating section,
wherein the information processing system has a configuration of the information processing system according to any one of (((1))) to (((15))).
(((17)))
An image forming apparatus comprising:
an accommodating section that accommodates a plurality of recording media;
a blowing device that blows gas onto the recording media accommodated in the accommodating section;
an image forming section that forms an image on a recording medium fed out from the accommodating section; and
an information processing system that processes information regarding the recording media accommodated in the accommodating section,
wherein the information processing system has a configuration of the information processing system according to any one of (((1))) to (((15))).
(((18)))
A program for causing a computer to implement:
an acquisition function of acquiring a medium image that is an image of a bundle of recording media consisting of a plurality of recording media, the bundle of recording media being in a state in which gas is being blown from a lateral side of the recording media; and
a generation function of generating information regarding a floating state of the bundle of recording media shown in the acquired medium image by using a trained model generated through machine learning using training data including an image of a bundle of recording media that is in a state in which gas is being blown from a lateral side and information regarding a floating state of the bundle of recording media shown in the image.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
acquire a medium image that is an image of a bundle of recording media consisting of a plurality of recording media, the bundle of recording media being in a state in which gas is being blown from a lateral side of the recording media; and
generate information regarding a floating state of the bundle of recording media shown in the acquired medium image by using a trained model generated through machine learning using training data including an image of a bundle of recording media that is in a state in which gas is being blown from a lateral side and information regarding a floating state of the bundle of recording media shown in the image.

2. The information processing system according to claim 1,
wherein the trained model is a trained model generated through machine learning using training data including an image of a bundle of recording media that is in a state in which gas is being blown from a lateral side and information indicating whether floating of the bundle of recording media shown in the image is favorable or not, and
the processor is configured to:
use the trained model to generate information indicating whether floating of the bundle of recording media shown in the acquired medium image is favorable or not.

3. The information processing system according to claim 1,
wherein the trained model is a trained model generated through machine learning using training data including an image of a bundle of recording media that is in a state in which gas is being blown from a lateral side, the image being obtained by an imaging unit that is in a state in which powder has adhered, and information regarding a floating state of the bundle of recording media shown in the image, and
the processor is configured to:
generate the information regarding the floating state of the bundle of recording media shown in the acquired medium image by using the trained model generated through machine learning using the training data including the image obtained by the imaging unit that is in a state in which powder has adhered.

4. The information processing system according to claim 3,
wherein the powder that has adhered to the imaging unit is paper dust, and
the processor is configured to:
generate the information regarding the floating state of the bundle of recording media shown in the acquired medium image by using the trained model generated through machine learning using the training data including the image obtained by the imaging unit that is in a state in which the paper dust has adhered.

5. The information processing system according to claim 1,
wherein the trained model is prepared for each type of recording medium constituting the bundle of recording media, and
the processor is configured to:
acquire type information that is information regarding a type of recording medium constituting the bundle of recording media shown in the medium image; and
generate the information regarding the floating state of the bundle of recording media shown in the acquired medium image by using the trained model corresponding to the type specified by the type information.

6. The information processing system according to claim 1,
wherein the processor is configured to:
acquire a plurality of medium images in which blowing conditions of gas are different from each other; and
use the trained model to generate, for each of the plurality of acquired medium images, the information regarding the floating state of the bundle of recording media shown in the medium image.

7. The information processing system according to claim 6,
wherein the trained model is a trained model generated through machine learning using training data including an image of a bundle of recording media that is in a state in which gas is being blown from a lateral side and information indicating whether floating of the bundle of recording media shown in the image is favorable or not, and
the processor is configured to:
use the trained model to generate, for each of the plurality of acquired medium images, information indicating whether floating of the bundle of recording media shown in the medium image is favorable or not.

8. The information processing system according to claim 1, wherein the processor is configured to:
operate a blowing device that blows gas onto the bundle of recording media under each of a plurality of conditions different from each other, and use the trained model to generate, for each medium image obtained under each of the conditions, state information that is information regarding the floating state of the bundle of recording media shown in the medium image.

9. The information processing system according to claim 8, wherein the processor is configured to:
in operating the blowing device under each of the plurality of conditions, obtain a plurality of medium images under each of the conditions;
use the trained model to generate, for each of the plurality of medium images obtained under each of the conditions, the state information that is information regarding the floating state of the bundle of recording media shown in the medium image; and
set a blowing condition of the blowing device in a case where feeding out of a recording medium is to be performed, based on a plurality of pieces of state information generated under each of the conditions.

10. The information processing system according to claim 8, wherein the processor is configured to:
in operating the blowing device under each of the plurality of conditions different from each other, operate the blowing device under each of a smaller number of conditions than a total number of all conditions included in the plurality of conditions, and set another condition in a case of operating the blowing device under the other condition, based on respective pieces of state information generated in correspondence with the smaller number of conditions.

11. The information processing system according to claim 10, wherein the processor is configured to:
set the other condition, based on a condition for operating the blowing device in a case where state information indicating a most favorable floating state is obtained, among the respective pieces of state information generated in correspondence with the smaller number of conditions.

12. The information processing system according to claim 11, wherein the processor is configured to:
set, as the other condition, a condition between the condition for operating the blowing device in a case where the state information indicating the most favorable floating state is obtained and a condition for operating the blowing device in a case where state information indicating a second most favorable floating state is obtained, among the respective pieces of state information generated in correspondence with the smaller number of conditions.

13. The information processing system according to claim 1, wherein the processor is configured to:
operate a blowing device that blows gas onto the bundle of recording media shown in the medium image under each of a plurality of conditions different from each other;
use the trained model to generate, for each medium image obtained under each of the conditions, state information that is information regarding the floating state of the bundle of recording media shown in the medium image;
set a blowing condition of the blowing device in a case where feeding out of a recording medium included in the bundle of recording media shown in the medium image is to be performed, based on the state information generated under each of the conditions;
store medium information that is information regarding the bundle of recording media shown in the medium image and the set blowing condition in an information storage unit in a state of being associated with each other; and
in a case where medium information that matches medium information regarding a newly installed bundle of recording media has been stored in the information storage unit, decide on a blowing condition of the blowing device in a case where feeding out of a recording medium included in the newly installed bundle of recording media is to be performed, based on the blowing condition associated with the medium information stored in the information storage unit.

14. The information processing system according to claim 1,
wherein the trained model is a trained model generated through machine learning using training data including an image of a bundle of recording media that is in a state in which gas is being blown from a lateral side, and information regarding a floating state of the bundle of recording media shown in the image and a folded state of a recording medium constituting the bundle of recording media shown in the image, and
the processor is configured to:
use the trained model to generate the information regarding the floating state of the bundle of recording media shown in the acquired medium image and information regarding a folded state of a recording medium constituting the bundle of recording media shown in the medium image.

15. The information processing system according to claim 1,
wherein at least a first trained model and a second trained model are prepared as the trained model,
the first trained model is a trained model generated through machine learning using training data including an image of a bundle of recording media in which the number of recording media constituting the bundle of recording media is less than a predetermined threshold value, the bundle of recording media being in a state in which gas is being blown from a lateral side, and information regarding a floating state of the bundle of recording media shown in the image,
the second trained model is a trained model generated through machine learning using training data including an image of a bundle of recording media in which the number of recording media constituting the bundle of recording media is greater than the predetermined threshold value, the bundle of recording media being in a state in which gas is being blown from a lateral side, and information regarding a floating state of the bundle of recording media shown in the image, and
the processor is configured to:
acquire sheet count information that is information regarding the number of recording media constituting the bundle of recording media shown in the medium image;
in a case where the number specified by the sheet count information is less than the predetermined threshold value, use the first trained model to generate the information regarding the floating state of the bundle of recording media shown in the acquired medium image; and
in a case where the number specified by the sheet count information is greater than the predetermined threshold value, use the second trained model to generate the information regarding the floating state of the bundle of recording media shown in the acquired medium image.

16. A recording medium accommodating device comprising:
an accommodating section that accommodates a plurality of recording media;
a blowing device that blows gas onto the recording media accommodated in the accommodating section; and
an information processing system that processes information regarding the recording media accommodated in the accommodating section,
wherein the information processing system has a configuration of the information processing system according to claim 1.

17. An image forming apparatus comprising:
an accommodating section that accommodates a plurality of recording media;
a blowing device that blows gas onto the recording media accommodated in the accommodating section;
an image forming section that forms an image on a recording medium fed out from the accommodating section; and
an information processing system that processes information regarding the recording media accommodated in the accommodating section,
wherein the information processing system has a configuration of the information processing system according to claim 1.

18. A non-transitory computer readable medium storing a program for causing a computer to implement:
an acquisition function of acquiring a medium image that is an image of a bundle of recording media consisting of a plurality of recording media, the bundle of recording media being in a state in which gas is being blown from a lateral side of the recording media; and
a generation function of generating information regarding a floating state of the bundle of recording media shown in the acquired medium image by using a trained model generated through machine learning using training data including an image of a bundle of recording media that is in a state in which gas is being blown from a lateral side and information regarding a floating state of the bundle of recording media shown in the image.

19. An information processing method comprising:
acquiring a medium image that is an image of a bundle of recording media consisting of a plurality of recording media, the bundle of recording media being in a state in which gas is being blown from a lateral side of the recording media; and
generating information regarding a floating state of the bundle of recording media shown in the acquired medium image by using a trained model generated through machine learning using training data including an image of a bundle of recording media that is in a state in which gas is being blown from a lateral side and information regarding a floating state of the bundle of recording media shown in the image.
